(19) United States
(12) Patent Application Publication
(10) Pub. No.: US 2021/0107467 A1
(43) Pub. Date: Apr. 15, 2021

(54) VEHICLE PARKING ASSIST APPARATUS

(71) Applicant: TOYOTA JIDOSHA KABUSHIKI KAISHA, Toyota-shi (JP)

(72) Inventors: Yu HIEI, Toyota-shi (JP); Yusuke KIDA, Tokyo (JP); Daiki MARUKI, Toyota-shi (JP)

(73) Assignee: TOYOTA JIDOSHA KABUSHIKI KAISHA, Toyota-shi (JP)

(21) Appl. No.: 17/066,080

(22) Filed: Oct. 8, 2020

(30) Foreign Application Priority Data
Oct. 11, 2019 (JP) 2019-187857

(51) Int. Cl. B60W 30/06; B60W 60/00; G08G 1/14; B60W 30/095; B60W 30/09; G08G 1/16

(52) U.S. Cl. CPC B60W 30/06; B60W 60/001; G08G 1/143; B60W 2554/00; B60W 30/09; G08G 1/168; B60W 2420/42; B60W 30/0956

(57) ABSTRACT

A vehicle parking assist apparatus acquires a feature image from a registration image representing a parking lot to register the feature image as parking lot information. The registration image is an image that a camera takes when the vehicle parking assist apparatus receives a registration request for registering a parking area in that the vehicle is parked. The vehicle parking assist apparatus determines that the vehicle has reached the parking area specified by the parking lot information when an image part that has the same feature as the feature image is included in a post registration image. The vehicle parking assist apparatus specifies an object image being an image representing a object from the registration image when the object is present in the area corresponding to the registration image; and acquires the feature image based on the registration image from which the specified object image is excluded.

### BACKGROUND

### Technical Field

The present disclosure is related to a vehicle parking assist apparatus.

### Related Art

There has been known a vehicle parking assist apparatus configured to autonomously park a vehicle in a parking lot that is not defined/partitioned with parking area lines such as white lines. The parking lot that is not defined/partitioned with parking area lines is, for example, a parking lot of a private house/residence. The known vehicle parking assist apparatus of this type registers/memorizes parking lot information on a parking lot that is not defined/partitioned with parking area lines, when parking of the vehicle in that parking lot is completed. As the known vehicle parking assist apparatus autonomously moves the vehicle to park the vehicle in the same parking lot in which the vehicle has been autonomously parked before, the vehicle parking assist apparatus periodically acquires information on the parking lot. The vehicle parking assist apparatus compares the acquired information with the registered/memorized parking lot information to realize a relationship in position between the vehicle and the parking lot so as to park the vehicle to the parking lot.

Such a vehicle parking assist apparatus is disclosed, for example, in Japanese patent Application Laid-Open Publication 2017-138664. The disclosed vehicle parking assist apparatus acquires an image including an object image of an object that is present in or around the parking lot using a camera so as to register/memorize at least one of feature points of the object in the image as the parking lot information. Hereinafter, that image including the object image is referred to as a “camera image”.

### SUMMARY

A case may occur where only a driver is in the vehicle when the parking lot information is being registered/memorized, but one or more passengers in addition to the driver are in the vehicle when the vehicle is autonomously parked in the parking lot whose parking lot information has been registered/memorized. In this case, an inclination of the vehicle of when the parking lot information is registered/memorized may be different from an inclination of the vehicle of when the vehicle is autonomously parked in the same parking lot using the registered/memorized parking lot information. There may be another case where “the parking lot whose parking lot information is registered/memorized” and/or “the surrounding of that parking lot” have/has an inclination and/or an undulation, and a route of when the parking lot information is registered/memorized is different from a route of when the vehicle is autonomously parked in the same parking lot using the registered/memorized parking lot information. In this case as well, the inclination of the vehicle of when the parking lot information is registered/memorized may be different from the inclination of the vehicle of when the vehicle is autonomously parked in the parking lot using the registered/memorized parking lot information.

In the above cases, a shape of the object in the camera image of when the parking lot information (i.e., the feature points) is registered/memorized may often be different from a shape of the same object in the camera image of when the vehicle is autonomously parked in the parking lot using the registered/memorized parking lot information. This may make it difficult to determine that the feature points of an object acquired when the vehicle is autonomously parked are the registered/memorized feature points of the same object. In this case, it may not be possible to autonomously park the vehicle in the parking lot.

Meanwhile, there may be another case where the parking lot information is registered in the morning, and the vehicle is autonomously parked in the afternoon. In this case, manners of the sunlight shining on the object directly and the sunlight shining reflected by the ground shining on the object vary between the time of the parking lot information being registered/memorized and the time of the vehicle being autonomously parked. Also, there may be another case where the parking lot information is registered/memorized in the daytime, and the vehicle is autonomously parked in the night-time. In this case, the manners of the sunlight shining on the object directly and the sunlight reflected by the ground shining on the object vary between the time of the parking lot information being registered and the time of the vehicle being autonomously parked. In these cases, the feature points of the object in the camera image may vary between the time of the parking lot information being registered/memorized and the time of the vehicle being autonomously parked. In this case, it may not be possible to determine that the feature points acquired at the time of the vehicle being autonomously parked are the registered feature points of the object even when the acquired feature points are the registered feature points of the object. In this case, it may not be possible to autonomously park the vehicle in the parking lot.

Further, there may be another case where the feature points of the movable object such as another vehicle, a bicycle and a plant pot are registered/memorized as the parking lot information, and the movable object has been moved when the vehicle is autonomously parked. In this case, the registered/memorized feature points of the movable object may not be acquired when the vehicle is autonomously parked. As a result, the vehicle may not be autonomously parked. Also, there may be another case where the movable object does not present in/around the parking lot when the parking lot information is registered/memorized, and the movable object presents in/around the parking lot when the vehicle is autonomously parked. In this case, the feature points of that movable object has not been registered/memorized. As a result, the vehicle may not be autonomously parked.

There may be another case where a position of the camera varies between the time of the parking lot information being registered/memorized and the time of the vehicle being autonomously parked in the parking lot. In this case, even if the object that is photographed when the parking lot information is registered/memorized is the same as the object that is photographed when the vehicle being autonomously parked in the parking lot, the shape of the object may vary between the time of the parking lot information being registered/memorized and the time of the vehicle being autonomously parked in the parking lot. In this case, it may not be possible to determine that the feature points acquired at the time of the vehicle being parked autonomously are the registered/memorized feature points of the object even when the acquired feature points are the registered/memorized feature points of the object. As a result, it may not be possible to autonomously park the vehicle in the parking lot.

If the vehicle parking assist apparatus is configured to register/memorize the feature points of the object as the parking lot information as described above, the vehicle may not be autonomously parked in the parking lot when the states surrounding the vehicle and the parking lot are different between the time of registering/memorizing the feature points and the time of autonomously parking the vehicle using the memorized feature points (parking lot information).

The present disclosure has been made to cope with problems described above. The present disclosure has an object to provide a vehicle parking assist apparatus which can park the vehicle in the parking lot autonomously even when the states surrounding the vehicle and the parking lot changes between the time of registering/memorizing the feature points and the time of autonomously parking the vehicle using the memorized feature points.

A vehicle parking assist apparatus according to the present disclosure comprises:

A vehicle parking assist apparatus comprising:

a camera (40, 41-44) configured to take an image representing an area of surroundings of a vehicle; and

a controller (90, 11, 12, 13) configured to:
register, as parking lot information, information on a parking lot including a parking area into which the vehicle is going to be parked, based on a registration image being an image representing the parking lot that the camera takes when the controller receives a registration request for registering the parking area from a driver of the vehicle; and
autonomously park the vehicle into the parking area based on the parking lot information, when the vehicle is determined to have reached the parking lot specified by the parking lot information after the parking lot information had been registered,

The controller is configured to:
acquire a feature image which is an image of a predetermined area size and has a specific feature from the registration image (Step 2450) so as to register the feature image as the parking lot information (Step 2545, Step 2565, Step 2620); and
determine that the vehicle has reached the parking area specified by the parking lot information (Step 2720) when an image part that has the same feature as the feature image is included in a post registration image (“Yes” at Step 2715) so as to autonomously park the vehicle into the parking area in the parking lot based on the parking lot information, the post registration image being an image of an area taken by the camera after the controller has registered the parking lot information,

and the controller is further configured to:
specify an object image being an image representing an object from the registration image (Step 2440) when the object is present in the area corresponding to the registration image (Step 2420); and
acquire the feature image based on the registration image from which the specified object image is excluded (Step 2540, Step 2565, Step 2620).

According to the above vehicle parking assist apparatus, the feature image is acquired from the image other than the object image which is the image representing the object so as to be registered as the parking lot information. The feature image representing the ground in/around the parking lot is registered as the parking lot information. The object image on which a change of a situation surrounding the vehicle and the parking lot has a great influence is masked/excluded. Even if the situation surrounding the vehicle and the parking lot varies between the time of the parking lot information being registered and the time after the parking lot information being registered, the vehicle parking assist apparatus can assuredly determine whether or not the vehicle reaches the parking lot specified by the parking lot information. Accordingly, even if the situation surrounding the vehicle and the parking lot varies between the time of the parking lot information being registered and the time after the parking lot information being registered, the vehicle can be parked into the parking area in the parking lot autonomously.

According to an aspect of the present disclosure,

the vehicle parking assist apparatus further comprises a detection sensor (30, 301-312) configured to radiate wireless medium to detect the object by receiving the wireless medium that the object reflects.

The controller is configured to:

determine that the object is present in the area corresponding to the registration image (“Yes” at Step 2420), in a case where the detection sensor detects the object when the controller receives the registration request; and

specify the object image from the registration image, based on the object which the detection sensor detects (Steps 2425-2445).

According to this aspect, the vehicle parking assist apparatus can correctly determine that the object is present.

According to an aspect of the present disclosure,

the controller is configured to:
acquire a plane view image, the plane view image being an image of when an image taken by the camera is viewed from a viewpoint that is positioned above the camera (Step 2415);
acquire a virtual line between a furthest point of detection results representing the object detected by the detection sensor in the plane view image and the camera, the furthest point being a point that has a longest distance to the camera among the detection results (Step 2430);
acquire a first virtual line that extends from the furthest point in a same direction with the virtual line, the direction being a direction away from the camera (Step 2430);
acquire a second virtual line that extends from a closest point of the detection results in a direction that is parallel with the center axis of the radiation range of the detection sensor, the closest point being a point that has a shortest distance to the camera (Step 2435); and
specify, as the object image, an image of an area which is defined by the detection results, the first virtual line, and the second virtual line (Step 2440).

According to this aspect, the image of the area which is defined by detection results representing the object detected by the detection sensor, the first virtual line, the second virtual line in the plane view image is specified as the object image. The object's height at the furthest point is converted to be extended in the same direction with the virtual line and away from the camera (in other word, to be extended along the first virtual line) in the plane view image, when the image taken by the camera is converted into the plane view image. The first virtual line is used for defining the object image so that the vehicle parking assist apparatus can specify the object image correctly.

The detection sensor cannot detect another object which is present behind a reflecting surface of the object with respect to the clearance sonar. The reflecting surface is a surface which the wireless medium radiated by the detection sensor reflects. The second virtual line extends from the closest point in the direction that is parallel with the center axis of the radiation range of the detection sensor. That second virtual line is used to define the object image so that the vehicle parking assist apparatus can include an area behind the reflecting surface (in other words, an area where another may be present) in the object image. Therefore, the image representing the object, which is affected by the change of the situation easily, is masked/excluded assuredly.

According to an aspect of the present disclosure,

the detection sensor and the camera are configured to be mounted on the vehicle in such a manner that a direction of the center axis of the radiation range of the detection sensor matches with a direction of a center axis of a shooting range of the camera.

According to this aspect, the vehicle parking assist apparatus can reduce a possibility that a line image representing the object's at the closets point protrudes from the second virtual line. Accordingly, the vehicle parking assist apparatus can reduce a possibility that an area which is a part of image representing the object and protrudes from the second virtual line is not included in the object image.

According to an aspect of the present disclosure,

the controller is configured to:

specify the object image which is an image representing the object from the post registration image (Step 2440) when the object is present in an area corresponding to the post registration image (“Yes” at Step 2420), and

determine whether or not an image other than the specified object image in the post registration image includes the feature image (Step 2710, Step 2715).

According to this aspect, the object image is masked/excluded in a post registration image taken by the camera after a registration of the parking lot information. Therefore, the vehicle parking assist apparatus can determine whether or not the vehicle reaches the parking lot specified by the parking lot information.

Elements of the present disclosure are not limited to elements of embodiments and modified examples of the present disclosure described along with the drawings. The other objects, features and accompanied advantages of the present disclosure can be easily understood from the embodiments and the modified examples of the present disclosure.

### BRIEF DESCRIPTION OF THE DRAWINGS

FIG. 1 is a view which shows a vehicle parking assist apparatus according to an embodiment of the present disclosure and a vehicle to which the vehicle parking assist apparatus according to the embodiment of the present disclosure is applied.

FIG. 2 is a view which shows a sonar sensor apparatus and detection ranges of the sonar sensor apparatus.

FIG. 3 is a view which shows a camera sensor apparatus and shooting areas of the camera sensor apparatus.

FIG. 4 is a view which shows an example of a parking lot.

FIG. 5 is a view which shows a front area and a rear area.

FIG. 6 is a view which shows a left area and a right area.

FIG. 7 is a view which shows feature points.

FIG. 8 is a view which shows a parking area.

FIG. 9A to FIG. 9D are views which show displays.

FIG. 10 is a view used for describing operations of the vehicle parking assist apparatus according to the embodiment of the present disclosure.

FIG. 11 is a view used for describing the operations of the vehicle parking assist apparatus according to the embodiment of the present disclosure.

FIG. 12 is a view used for describing the operations of the vehicle parking assist apparatus according to the embodiment of the present disclosure.

FIG. 13 is a view which shows entrance feature points.

FIG. 14 is a view used for describing the operations of the vehicle parking assist apparatus according to the embodiment of the present disclosure.

FIG. 15 is a view used for describing the operations of the vehicle parking assist apparatus according to the embodiment of the present disclosure.

FIG. 16 is a view used for describing the operations of the vehicle parking assist apparatus according to the embodiment of the present disclosure.

FIG. 17 is a view used for describing the operations of the vehicle parking assist apparatus according to the embodiment of the present disclosure.

FIG. 18A and FIG. 18B are views which show the displays.

FIG. 19 is a view which shows an example of a parking lot where a wall is present.

FIG. 20 is a view which shows an parking lot image (a left camera image) taken by a left camera.

FIG. 21 is a view which shows a plane view image into which the left side came image is converted.

FIG. 22 is a view shows detection results of the sonar sensor apparatus.

FIG. 23 is a view used for describing a process for specifying a object.

FIG. 24 is a view which shows a flowchart of a routine executed by a CPU of an ECU shown in FIG. 1.

FIG. 25 is a view which shows a flowchart of a routine executed by the CPU.

FIG. 26 is a view which shows a flowchart of a routine executed by the CPU.

FIG. 27 is a view which shows a flowchart of a routine executed by the CPU.

FIG. 28 is a view which shows a flowchart of a routine executed by the CPU.

### DETAIL DESCRIPTION

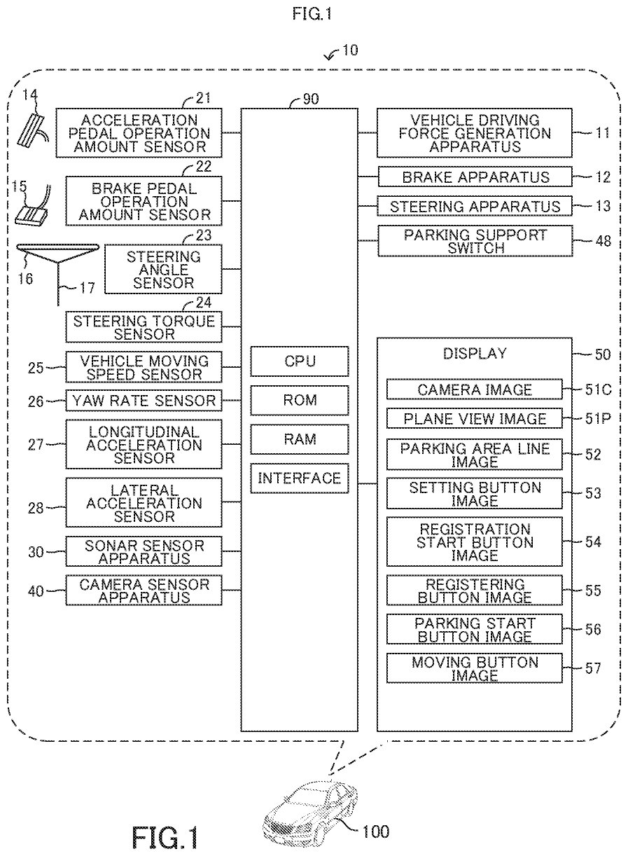

A vehicle parking assist apparatus according to an embodiment of the present disclosure will be described with reference to the drawings. FIG. 1 shows the vehicle parking assist apparatus 10 according to the embodiment of the present disclosure and a vehicle 100 to which the vehicle parking assist apparatus 10 is applied.

As shown in FIG. 1, the vehicle parking assist apparatus 10 includes an ECU 90. ECU stands for electronic control unit. The ECU 90 includes a microcomputer as a main component. The microcomputer includes a CPU, a ROM, a RAM, a non-volatile memory, and an interface. The CPU is configured or programmed to realize various functions by executing instructions, programs, or routines stored in the ROM.

The vehicle 100 is installed with a vehicle driving force generation apparatus 11, a brake apparatus 12, and a steering apparatus 13. The vehicle driving force generation apparatus 11 generates a driving force for driving the vehicle 100 and applies the driving force to driving wheels of the vehicle 100. The vehicle driving force generation apparatus 11 is, for example, an internal combustion engine and/or electric motor. The brake apparatus 12 applies braking forces to wheels of the vehicle 100 to brake the vehicle 100. The steering apparatus 13 applies a steering torque to steered wheels to steer the vehicle 100.

The vehicle driving force generation apparatus 11, the brake apparatus 12, and the steering apparatus 13 are electrically connected to the ECU 90. The ECU 90 controls operations of the vehicle driving force generation apparatus 11 to control the driving force applied to the driving wheels of the vehicle 100. The ECU 90 controls operations of the brake apparatus 12 to control the braking forces applied to the wheels of the vehicle 100. The ECU 90 controls operations of the steering apparatus 13 to control the steering torque applied to the steered wheels to steer the vehicle 100.

<Sensors>

The vehicle parking assist apparatus 10 includes an acceleration pedal operation amount sensor 21, a brake pedal operation amount sensor 22, a steering angle sensor 23, a steering torque sensor 24, a vehicle moving speed sensor 25, a yaw rate sensor 26, a longitudinal acceleration sensor 27, a lateral acceleration sensor 28, a sonar sensor apparatus 30, a camera sensor apparatus 40, a parking assist switch 48, and a display 50.

The acceleration pedal operation amount sensor 21 is electrically connected to the ECU 90. The ECU 90 detects an amount AP of an operation applied to an acceleration pedal 14 by the acceleration pedal operation amount sensor 21 and acquires the amount AP as an acceleration pedal operation amount AP. The ECU 90 controls the operations of the vehicle driving force generation apparatus 11 to apply the driving force to the driving wheels of the vehicle 100 in accordance with the acquired acceleration pedal operation amount AP.

The brake pedal operation amount sensor 22 is electrically connected to the ECU 90. The ECU 90 detects an amount BP of an operation applied to a brake pedal 15 by the brake pedal operation amount sensor 22 and acquires the amount BP as a brake pedal operation amount BP. The ECU 90 controls the operations of the brake apparatus 12 to apply the braking forces to the wheels in accordance with the acquired brake pedal operation amount BP.

The steering angle sensor 23 is electrically connected to the ECU 90. The ECU 90 detects an angle θst of rotation of a steering wheel 16 relative to a center position by the steering angle sensor 23 and acquires the angle θst as a steering angle θst.

The steering torque sensor 24 is electrically connected to the ECU 90. The ECU 90 detects a torque TQst input to a steering shaft 17 by a driver of the vehicle 100 via the steering torque sensor 24 and acquires the torque TQst as a steering torque TQst.

The ECU 90 controls the operations of the steering apparatus 13 to apply the steering torque to the steered wheels of the vehicle 100 in accordance with the acquired steering angle θst and the acquired steering torque TQst.

The vehicle moving speed sensor 25 is electrically connected to the ECU 90. The ECU 90 detects rotation speeds Vrot of the wheels of the vehicle 100 by the vehicle moving speed sensor 25 and acquires the rotation speeds Vrot of the wheels of the vehicle 100. The ECU 90 acquires a moving speed SPD of the vehicle 100 as a vehicle moving speed SPD, based on the acquired rotation speeds Vrot of the wheels of the vehicle 100.

The yaw rate sensor 26 is electrically connected to the ECU 90. The ECU 90 detects a yaw rate YR of the vehicle 100 by the yaw rate sensor 26 and acquires the yaw rate YR of the vehicle 100 as a vehicle yaw rate YR.

The longitudinal acceleration sensor 27 is electrically connected to the ECU 90. The ECU 90 detects a longitudinal acceleration Gx of the vehicle 100 by the longitudinal acceleration sensor 27 and acquires the longitudinal acceleration Gx as a vehicle longitudinal acceleration Gx.

The lateral acceleration sensor 28 is electrically connected to the ECU 90. The ECU 90 detects a lateral acceleration Gy of the vehicle 100 by the lateral acceleration sensor 28 and acquires the lateral acceleration Gy as a vehicle lateral acceleration Gy.

The sonar sensor apparatus 30 includes a first clearance sonar 301 to a twelfth clearance sonar 312.

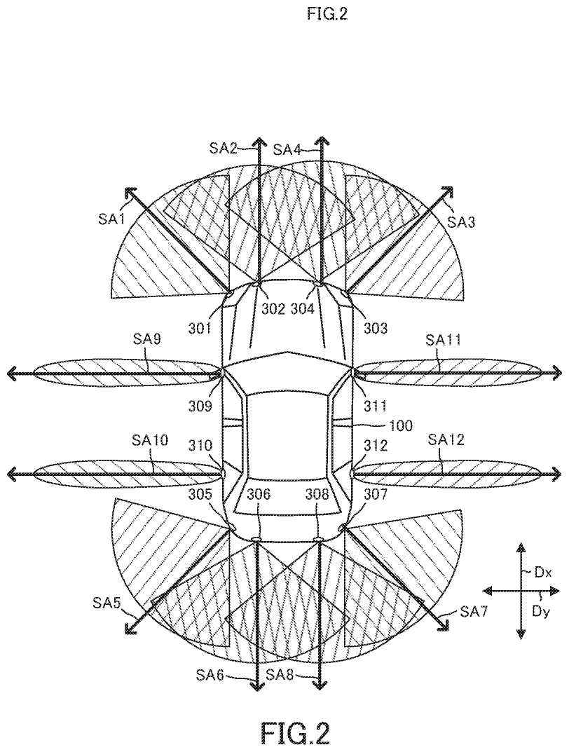

A direction Dx shown in FIG. 2 is a longitudinal direction of the vehicle 100. Hereinafter, the direction Dx will be referred to as “the vehicle longitudinal direction Dx.” A direction Dw shown in FIG. 2 is a width direction of the vehicle 100. Hereinafter, the direction Dw will be referred to as “the vehicle width direction Dy.”

As shown in FIG. 2, the first clearance sonar 301 is mounted on a left end of a front end portion of the vehicle 100 to radiate sonic waves forward left. More specifically, the first clearance sonar 301 is mounted in such a manner that a center axis SA1 of a radiation range of the sonic waves radiated by the first clearance sonar 301 is tilted 45 degrees leftward with respect to the vehicle longitudinal direction Dx. The second clearance sonar 302 is mounted on the front end portion of the vehicle 100 between the left end of the front end portion of the vehicle 100 and a center of the front end portion of the vehicle 100 to radiate the sonic waves forward straight. More specifically, the second clearance sonar 302 is mounted in such a manner that a center axis SA2 of the radiation range of the sonic waves radiated by the second clearance sonar 302 is matched with the vehicle longitudinal direction Dx. The third clearance sonar 303 is mounted on a right end of the front end portion of the vehicle 100 to radiate the sonic waves forward right. More specifically, the third clearance sonar 303 is mounted in such a manner that a center axis SA3 of the radiation range of the sonic waves radiated by the third clearance sonar 303 is tilted 45 degrees rightward with respect to the vehicle longitudinal direction Dx. The fourth clearance sonar 304 is mounted on the front end portion of the vehicle 100 between the right end of the front end portion of the vehicle 100 and the center of the front end portion of the vehicle 100 to radiate the sonic waves forward straight. More specifically, the forth clearance sonar 304 is mounted in such a manner that a center axis SA4 of the radiation range of the sonic waves radiated by the fourth clearance sonar 304 is matched with the vehicle longitudinal direction Dx.

The fifth clearance sonar 305 is mounted on a left end of a rear end portion of the vehicle 100 to radiate the sonic waves rearward left. More specifically, the fifth clearance sonar 305 is mounted in such a manner that a center axis SA5 of a radiation range of the sonic waves radiated by the fifth clearance sonar 305 is tilted 45 degrees leftward with respect to the vehicle longitudinal direction Dx. The sixth clearance sonar 306 is mounted on the rear end portion of the vehicle 100 between the left end of the rear end portion of the vehicle 100 and a center of the rear end portion of the vehicle 100 to radiate the sonic waves rearward straight. More specifically, the sixth clearance sonar 306 is mounted in such a manner that a center axis SA6 of the radiation range of the sonic waves radiated by the sixth clearance sonar 306 is matched with the vehicle longitudinal direction Dx. The seventh clearance sonar 307 is mounted on a right end of the rear end portion of the vehicle 100 to radiate the sonic waves rearward right. More specifically, the seventh clearance sonar 307 is mounted in such a manner that a center axis SA7 of the radiation range of the sonic waves radiated by the seventh clearance sonar 307 is tilted 45 degrees rightward with respect to the vehicle longitudinal direction Dx. The eighth clearance sonar 308 is mounted on the rear end portion of the vehicle 100 between the right end of the rear end portion of the vehicle 100 and the center of the rear end portion of the vehicle 100 to radiate the sonic waves rearward straight. More specifically, the eighth clearance sonar 308 is mounted in such a manner that a center axis SA8 of the radiation range of the sonic waves radiated by the eighth clearance sonar 308 is matched with the vehicle longitudinal direction Dx.

The ninth clearance sonar 309 is mounted on a front side of a left side portion of the vehicle 100 to radiate the sonic waves leftward straight. More specifically, the ninth clearance sonar 309 is mounted in such a manner that a center axis SA9 of the radiation range of the sonic waves radiated by the ninth clearance sonar 309 is matched with the vehicle width direction Dy. The tenth clearance sonar 310 is mounted on a rear side of the left side portion of the vehicle 100 to radiate the sonic waves leftward straight. More specifically, the tenth clearance sonar 310 is mounted in such a manner that a center axis SA10 of the radiation range of the sonic waves radiated by the tenth clearance sonar 310 is matched with the vehicle width direction Dy. The eleventh clearance sonar 311 is mounted on a front side of a right side portion of the vehicle 100 to radiate the sonic waves rightward straight. More specifically, the eleventh clearance sonar 311 is mounted in such a manner that a center axis SA11 of the radiation range of the sonic waves radiated by the eleventh clearance sonar 311 is matched with the vehicle width direction Dy. The twelfth clearance sonar 312 is mounted on a rear side of the right side portion of the vehicle 100 to radiate the sonic waves rightward straight. More specifically, the twelfth clearance sonar 312 is mounted in such a manner that a center axis SA12 of the radiation range of the sonic waves radiated by the twelfth clearance sonar 312 is matched with the vehicle width direction Dy.

Each of the first clearance sonar 301 to the twelfth clearance sonar 312 receives the sonic waves reflected by a three-dimensional object. Hereinafter, the three-dimensional object is referred to an “object”.

The sonar sensor apparatus 30 is electrically connected to the ECU 90. The sonar sensor apparatus 30 sends information on (i) the sonic waves radiated from the first clearance sonar 301 to the twelfth clearance sonar 312 and (ii) the sonic waves received by the first clearance sonar 301 to the twelfth clearance sonar 312. The ECU 90 acquires information on the objects around the vehicle 100 as object information OBJ, based on the information sent from the sonar sensor apparatus 30. Hereinafter, the information on the objects (i.e., object information OBJ) obtained based on the sonar sensor apparatus 30 will be referred to as “the sonar information SON.”

The camera sensor apparatus 40 includes a front camera 41, a rear camera 42, a left camera 43, and a right camera 44. Hereinafter, the cameras 45 includes the front camera 41, the rear camera 42, the left camera 43, and the right camera 44.

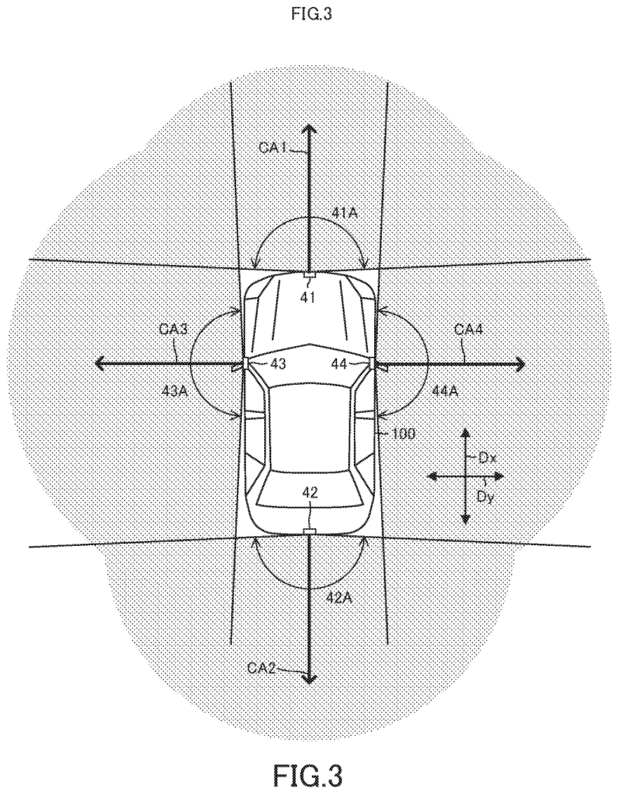

As shown in FIG. 3, the front camera 41 is mounted on the center of the front end portion of the vehicle 100 to take (capture) images of a view ahead of the vehicle 100. A field angle 41A of the front camera 41 is about 180 degrees. The rear camera 42 is mounted on the center of the rear end portion of the vehicle 100 to take (capture) images of a view behind the vehicle 100. A field angle 42A of the rear camera 42 is about 180 degrees. It should be noted that a shooting area of each of the front camera 41 and the rear camera 42 extends to the vehicle longitudinal direction Dx. The left camera 43 is mounted on the left side portion of the vehicle 100 to take images of a view at the left of the vehicle 100. A field angle 43A of the left camera 43 is about 180 degrees. The right camera 44 is mounted on the right side portion of the vehicle 100 to take images of a view at the right of the vehicle 100. Afield angle 44A of the right camera 44 is about 180 degrees. It should be noted that a shooting area of each of the left camera 43 and the right camera 44 extends to the vehicle width direction Dy.

The camera sensor apparatus 40 is electrically connected to the ECU 90. The ECU 90 acquires information on the images of the views taken by the cameras 45 of the camera sensor apparatus 40.

Hereinafter, the information on the images of the view taken by the front camera 41 will be referred to as “the front image information IMG1.” Similarly, the information on the images of the view taken by the rear camera 42 will be referred to as “the rear image information IMG2.” In addition, the information on the images of the view taken by the left camera 43 will be referred to as “the left image information IMG3.” The information on the images of the view taken by the right camera 44 will be referred to as “the right image information IMG4.” Furthermore, the front image information IMG1, the rear image information IMG2, the left image information IMG3, and the right image information IMG4 will be collectively referred to as “the image information IMG.”

The vehicle parking assist apparatus 10 acquires (information on) feature point(s) F, based on the image information IMG when predetermined low speed condition becomes satisfied. The predetermined low speed condition is a condition to be satisfied when the vehicle moving speed SPD is equal to or lower than a speed threshold SPDth. The feature point F is a part of the image taken by each of the cameras 45 in which a luminance greatly varies within the image. The feature point F may be referred to as a “feature image”.

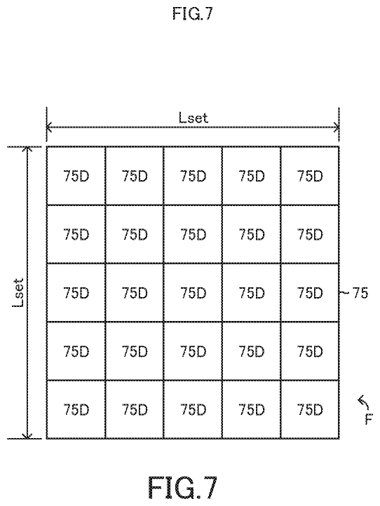

Specifically, as described later in greater detail, the apparatus 10 produces a plane view image based on the image information IMG, and takes/cuts out the part in which the luminance greatly varies from the plane view image, as the feature point F (namely, as the feature image). The thus extracted feature image which will be described later in greater detail with reference to FIG. 7 has a square shape having a side whose length corresponds to a predetermined actual distance Lset.

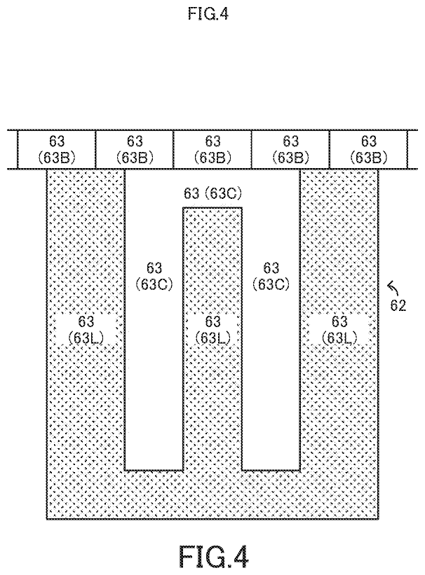

For example, when the cameras 45 take the images of a parking lot 62 shown in FIG. 4, various feature points described below can be obtained. The parking lot 62 shown in FIG. 4 has a ground 63 that includes a concrete part 63C, a part (lawn part) covered by lawn 63L, and concrete plates (blocks) 63B that close/cover a road gutter at an entrance (62ent) of the parking lot 62. The concrete plates 63B are arranged in line. Therefore, the ground 63 of the entrance 62ent of the parking lot 62 is formed by surfaces of the concrete plates 63B.

Based on the images of a parking lot 62 shown in FIG. 4, the feature points F described below are acquired.
Images corresponding to four corners of each of the concrete plates 63B;
Images corresponding to projected corners of the lawn 63L; and
Images corresponding to a part where the concrete plate 63B and the lawn 63L abut each other.

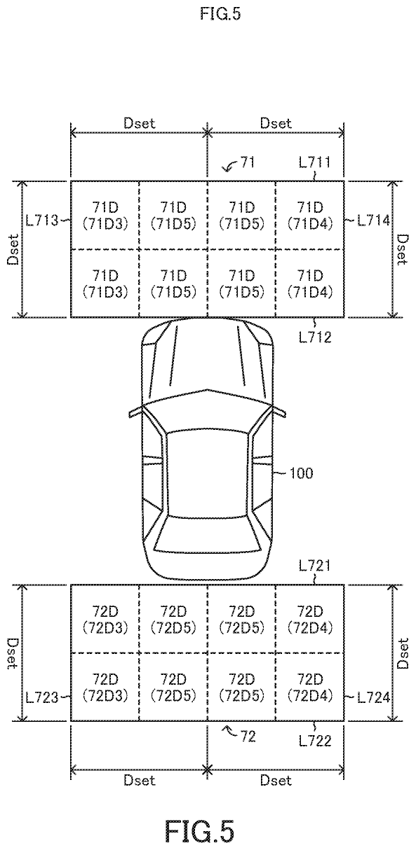

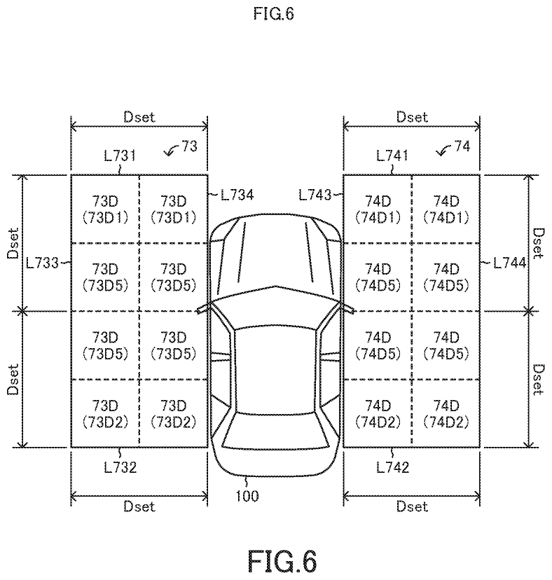

The vehicle parking assist apparatus 10 acquires the feature points (feature images) F in a predetermined area (a front area) 71 of the ground 63 located on the front side of the vehicle 100, based on the front image information IMG1 (see FIG. 5). Hereinafter, the feature points F in the predetermined area 71 will be referred to as “the front feature points F1.” In addition, the vehicle parking assist apparatus 10 acquires the feature points (feature images) F in a predetermined area (a rear area) 72 of the ground 63 located on the rear side of the vehicle 100, based on the rear image information IMG2 (see FIG. 5). Hereinafter, the feature points F in the predetermined area 72 will be referred to as “the rear feature points F2.” The vehicle parking assist apparatus 10 acquires the feature points (feature images) F in a predetermined area (a left side area) 73 of the ground 63 located on the left side of the vehicle 100, based on the left image information IMG3 (see FIG. 6). Hereinafter, the feature points F in the predetermined area 73 will be referred to as “the left feature points F3.” In addition, the vehicle parking assist apparatus 10 acquires the feature points (feature images) F in a predetermined area (a right side area) 74 of the ground 63 located on the right side of the vehicle 100, based on the right image information IMG4 (see FIG. 6). Hereinafter, the feature points F in the predetermined area 74 will be referred to as “the right feature points F4.”

As described above, in order to acquire the future points, the vehicle parking assist apparatus 10 converts the image taken by each of the cameras 45 into a plane view image described below so as to specify an object image Pobj described later in the plane view image, and acquires the feature points F from an image other than the object image Pobj in the plane view image. The plane view image is an image viewed from a virtual view point (a bird's eye) that is positioned immediately above each of the respective cameras 45. The vehicle parking assist apparatus 10 specifies “a part of the image that is likely to represent an object” as “the object image Pobj”.

As shown in FIG. 5, the predetermined area 71 is an area defined (surrounded) by a line L711, a line L712, a line L713, and a line L714. The line L711 extends in parallel to the vehicle width direction Dy, passing through a point away forward from the front camera 41 by a predetermined distance Dset. The line L712 extends in parallel to the vehicle width direction Dy, passing through the front camera 41. The line L713 extends in parallel to the vehicle longitudinal direction Dx, passing through a point away leftward from the front camera 41 by the predetermined distance Dset. The line L714 extends in parallel to the vehicle longitudinal direction Dx, passing through a point away rightward from the front camera 41 by the predetermined distance Dset. Hereinafter, the predetermined area 71 will be referred to as “the front area 71”.

The front area 71 is quadrisected in the vehicle width direction Dy and bisected in the vehicle longitudinal direction Dx. Therefore, the front area 71 includes eight areas 71D. In other words, the front area 71 is divided into the eight areas 71D having the same sizes (and shapes). Hereinafter, each of the areas 71D will be referred to as “the front divided area 71D.” Further, each of two of the front divided areas 71D located at the left end of the front area 71 in the vehicle width direction Dy will be referred to as “the left end divided area 71D3.” Further, each of two of the front divided areas 71D located at the right end of the front area 71 in the vehicle width direction Dy will be referred to as “the right end divided area 71D4.” Further, each of four of the front divided areas 71D located in the middle of the front area 71 in the vehicle width direction Dy will be referred to as “the middle divided area 71D5.”

As shown in FIG. 5, the predetermined area 72 is an area defined (surrounded) by a line L721, a line L722, a line L723, and a line L724. The line L721 extends in parallel to the vehicle width direction Dy, passing through the rear camera 42. The line L722 extends in parallel to the vehicle width direction Dy, passing through a point away rearward from the rear camera 42 by the predetermined distance Dset. The line L723 extends in parallel to the vehicle longitudinal direction Dx, passing through a point away leftward from the rear camera 42 by the predetermined distance Dset. The line L724 extends in parallel to the vehicle longitudinal direction Dx, passing through a point away rightward from the rear camera 42 by the predetermined distance Dset. Hereinafter, the predetermined area 72 will be referred to as “the rear area 72.”

The rear area 72 is quadrisected in the vehicle width direction Dy and bisected in the vehicle longitudinal direction Dx. Therefore, the rear area 72 includes eight areas 72D. In other words, the rear area 72 is divided into the eight areas 72D having the same sizes (and shapes). Hereinafter, each of the areas 72D will be referred to as “the rear divided area 72D.” Further, each of two of the rear divided areas 72D located at the left end of the rear area 72 in the vehicle width direction Dy will be referred to as “the left end divided area 72D3.” Further, each of two of the rear divided areas 72D located at the right end of the rear area 72 in the vehicle width direction Dy will be referred to as “the right end divided area 72D4.” Further, each of four of the rear divided areas 72D located in the middle of the rear area 72 in the vehicle width direction Dy will be referred to as “the middle divided area 72D5.”

As shown in FIG. 6, the predetermined area 73 is an area defined (surrounded) by a line L731, a line L732, a line L733, and a line L734. The line L731 extends in parallel to the vehicle width direction Dy, passing through a point away forward from the left camera 43 by the predetermined distance Dset. The line L732 extends in parallel to the vehicle width direction Dy, passing through a point away rearward from the left camera 43 by the predetermined distance Dset. The line L733 extends in parallel to the vehicle longitudinal direction Dx, passing through a point away leftward from the left camera 43 by the predetermined distance Dset. The line L734 extends in parallel to the vehicle longitudinal direction Dx, passing through the left camera 43. Hereinafter, the predetermined area 73 will be referred to as “the left area 73.”

The left area 73 is quadrisected in the vehicle longitudinal direction Dx and bisected in the vehicle width direction Dy. Therefore, the left area 73 includes eight areas 73D. In other words, the left area 73 is divided into the eight areas 73D having the same sizes (and shapes). Hereinafter, each of the areas 73D will be referred to as “the left divided area 73D.” Further, each of two of the left divided areas 73D located at the front end of the left area 73 in the vehicle longitudinal direction Dx will be referred to as “the front end divided area 73D1.” Further, each of two of the left divided areas 73D located at the rear end of the left area 73 in the vehicle longitudinal direction Dx will be referred to as “the rear end divided area 73D2.” Further, each of four of the left divided areas 73D located in the middle of the left area 73 in the vehicle longitudinal direction Dx will be referred to as “the middle divided area 73D5.”

As shown in FIG. 6, the predetermined area 74 is an area defined (surrounded) by a line L741, a line L742, a line L743, and a line L744. The line L741 extends in parallel to the vehicle width direction Dy, passing through a point away forward from the right camera 44 by the predetermined distance Dset. The line L742 extends in parallel to the vehicle width direction Dy, passing through a point away rearward from the right camera 44 by the predetermined distance Dset. The line L743 extends in parallel to the vehicle longitudinal direction Dx, passing through the right camera 44. The line L744 extends in parallel to the vehicle longitudinal direction Dx, passing through a point away rightward from the right camera 44 by the predetermined distance Dset. Hereinafter, the predetermined area 74 will be referred to as “the right area 74.”

The right area 74 is quadrisected in the vehicle longitudinal direction Dx and bisected in the vehicle width direction Dy. Therefore, the right area 74 includes eight areas 74D. In other words, the right area 74 is divided into the eight areas 74D having the same sizes (and shapes). Hereinafter, each of the areas 74D will be referred to as “the right divided area 74D.” Further, each of two of the right divided areas 74D located at the front end of the right area 74 in the vehicle longitudinal direction Dx will be referred to as “the front end divided area 7401.” Further, each of two of the right divided areas 74D located at the rear end of the right area 74 in the vehicle longitudinal direction Dx will be referred to as “the rear end divided area 7402.” Further, each of four of the right divided areas 74D located in the middle of the right area 74 in the vehicle longitudinal direction Dx will be referred to as “the middle divided area 74D5.”

As described above, each of the feature points F (i.e., each of the feature images) corresponds to the square area 75 shown in FIG. 7. The length of each of sides is the predetermined length Lset. When a predetermined condition becomes satisfied, the vehicle parking assist apparatus 10 divides each of the feature points F into twenty five square areas 75D that are the same as each other, and acquires luminance values LUM of the areas 75D. Then, the vehicle parking assist apparatus 10 acquires values DLUM by subtracting an average value LUMave of the acquired luminance values LUM from each of the luminance values LUM (DLUM=LUM−LUMave). Then, the vehicle parking assist apparatus 10 acquires differences between the luminance values LUM of the feature point F, based on the values DLUM. Then, the vehicle parking assist apparatus 10 acquires a pattern of the acquired differences as luminance pattern information CT. Basically, when the predetermined condition becomes satisfied, the vehicle parking assist apparatus 10 acquires, as the luminance pattern information CT, the luminance pattern of each of the feature points (feature images) F based on the image information IMG obtained by the cameras 45.

The parking assist switch 48 is provided at a portion in the vicinity of the steering wheel 16. The parking assist switch 48 is electrically connected to the ECU 90. The driver operates the parking assist switch 48 to start a parking assist control described later.

The display 50 is provided at a part of the vehicle 100 where the driver can see. In this embodiment, the display 50 is a display included in a so-called navigation apparatus.

The display 50 is electrically connected to the ECU 90. The ECU 90 can let the display 50 display various images. In this embodiment, the ECU 90 can let the display 50 display a camera image 51C, a plane view image 51P, a parking area line image 52, a setting button image 53, a registration start button image 54, a registering button image 55, a parking start button image 56, and a displacing button image 57.

The camera image 51C is an image taken by any one of the cameras 45.

The plane view image 51P is an image including a vehicle plane view image and a vehicle surrounding image. The vehicle plane view image is an image representing the vehicle 100, viewed vertically from the above. The vehicle surrounding image is an image representing surroundings of the vehicle 100, viewed vertically from the above. The vehicle surrounding image includes at least an image representing the parking lot 62. The vehicle plane view image and the vehicle surrounding image (i.e., the birds-eye view of the vehicle 100) are prepared by the ECU 90, based on the image information IMG.

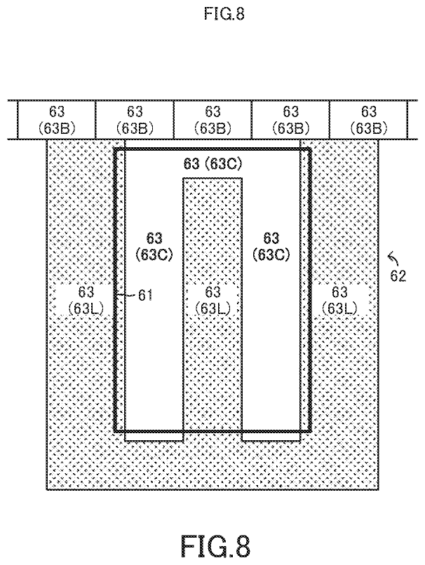

The parking area line image 52 is an image representing the parking area 61. The parking area 61 is an area or a space or a region in which the vehicle 100 is to be parked by the parking assist control. As shown in FIG. 8, the parking area 61 is set in the parking lot 62.

The setting button image 53 is an image representing a setting button to which the driver can apply the touch interaction to set or fix or determine the parking area 61 into which the driver desires to park the vehicle 100 by the parking assist control.

The registration start button image 54 is an image representing a registration (memorizing) start button to which the driver can apply the touch interaction to let the vehicle parking assist apparatus 10 start an execution of a first parking moving process described later of the parking assist control.

The registering button image 55 is an image representing a registering (memorizing) button to which the driver can apply the touch interaction to let the vehicle parking assist apparatus 10 register/memorize therein (in particular, the RAM of the ECU 90) the parking lot information Ipark acquired by the parking assist control. The parking lot information Ipark is information on the parking lot 62 used by the vehicle parking assist apparatus 10 to autonomously park the vehicle 100 into the parking lot 62.

The parking start button image 56 is an image representing a parking start button to which the driver can apply the touch interaction to let the vehicle parking assist apparatus 10 start the execution of the parking assist control to park the vehicle 100 into the parking area 61 registered/memorized in the vehicle parking assist apparatus 10.

The displacing button image 57 includes an upward displacing button image 57U, a downward displacing button image 57D, a leftward displacing button image 57L, and a rightward displacing button image 57R. The upward displacing button image 57U is an image to which the driver can apply the touch interaction to displace the parking area line image 52 upward on the display 50. The downward displacing button image 57D is an image to which the driver can apply the touch interaction to displace the parking area line image 52 downward on the display 50. The leftward displacing button image 57L is an image to which the driver can apply the touch interaction to displace the parking area line image 52 leftward on the display 50. The rightward displacing button image 57R is an image to which the driver can apply the touch interaction to displace the parking area line image 52 rightward on the display 50.

<Outline of Parking Assist Control>

Next, an outline (summary) of parking assist control will be described. The vehicle parking assist apparatus 10 is configured to execute the parking assist control. The parking assist control is a control to autonomously/automatically park the vehicle 100 into the parking area 61 without requiring any operations applied to the acceleration pedal 14, the brake pedal 15, and the steering wheel 16 by the driver.

There are parking lots in which the parking areas are partitioned (defined) by lines such as white lines. Hereinafter, each of the lines partitioning (defining) the parking areas will be referred to as “the parking area line.” In the parking lot in which the parking areas are partitioned by the parking area lines, the vehicle parking assist apparatus 10 can use the parking area lines recognized using the cameras 45 to autonomously park the vehicle into the parking area.

On the other hand, there are parking lots, such as the parking lot of the private house/residence, in which the parking areas are not partitioned by the parking area lines. In the parking lot in which the parking areas are not partitioned by the parking area lines, the vehicle parking assist apparatus 10 cannot utilize the parking area lines to autonomously park the vehicle 100 into the parking area. The parking assist control which the vehicle parking assist apparatus 10 executes, includes (i) a control to autonomously park the vehicle into the parking lot and register/memorize the parking lot information on the parking lot while the vehicle is being parked into that parking lot, and (ii) a 22, control to autonomously park the vehicle into the parking lot whose parking lot information has already been registered/memorized.

In a case where the parking lot information has already been registered/memorized, the vehicle parking assist apparatus 10 searches a left camera image Pleft and a right camera image Pright to find out image parts having the substantially same luminance patterns as the luminance patterns of registered entrance luminance pattern information CTent_reg, when the vehicle 100 has stopped. The left camera image is an image that is taken by the left camera 43. The right camera image is an image that is taken by the right camera 44. The registered entrance luminance pattern information CTent_reg is the luminance pattern information CT of entrance feature points Fent which has been registered/memorized or stored in the vehicle parking assist apparatus 10 through the parking assist control. The entrance feature points Fent are the feature points F of the entrance 62ent of the parking lot 62 acquired through the parking assist control. The left camera image Pleft and the right camera image Pright that are taken by the left camera 43 and the right camera 44, respectively, when the vehicle 100 has stopped (before parking), in the case where the parking lot information has already been registered/memorized are referred to as “images after registration” or “post registration images”.

When the vehicle parking assist apparatus 10 has succeeded to find the image parts having the substantially same luminance patterns as the luminance patterns of registered entrance luminance pattern information CTent_reg within the left camera image Pleft, the vehicle parking assist apparatus 10 determines that registered parking lot 62 is present at the left side of the vehicle 100 that has been stopped. The registered parking lot 62 is the parking lot whose parking lot information Ipark has already been registered/memorized or stored in the vehicle parking assist apparatus 10 through the parking assist control.

Whereas, when the vehicle parking assist apparatus 10 has succeeded to find the image parts having the substantially same luminance patterns as the luminance patterns of registered entrance luminance pattern information CTent_reg within the right camera image Pright, the vehicle parking assist apparatus 10 determines that registered parking lot 62 is present at the right side of the vehicle 100 that has been stopped.

<Registration of Parking Lot>

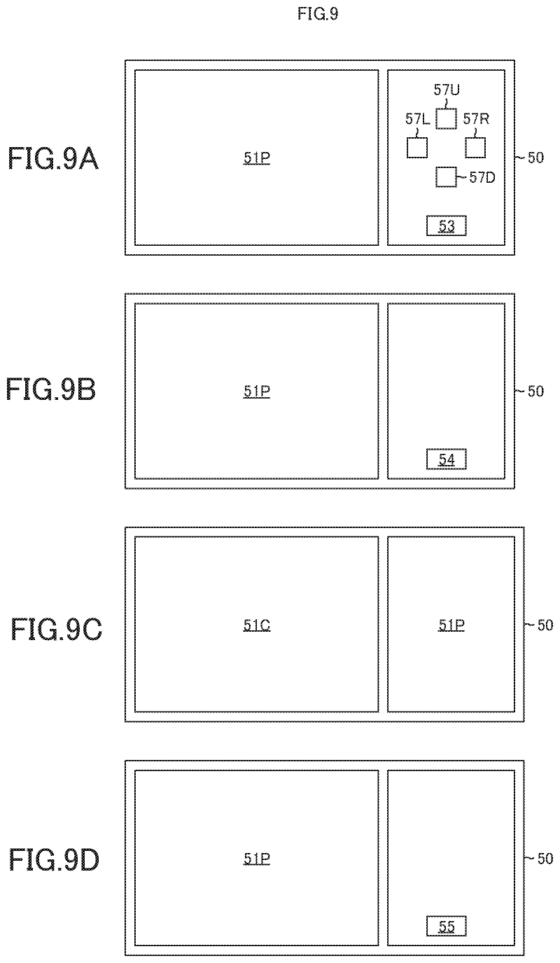

When a registration (memorization) start condition is satisfied, the vehicle parking assist apparatus 10 acquires preliminary entrance information Ient_pre and preliminary midway information Imid_pre as described below. The registration start condition is satisfied in a case where (i) the vehicle parking assist apparatus 10 determines that the vehicle 100 has stopped, (ii) the parking assist switch 48 is operated, and (iii) the vehicle parking assist apparatus 10 determines that the parking lot 62 that is present near the vehicle 100 is not the registered parking lot 62. In addition, the vehicle parking assist apparatus 10 registers/memorizes or stores, as the parking lot information Ipark, (i) registration entrance information Ient_reg, (ii) registration inside information Iin_reg, and (iii) registration area information Iarea_reg as described below. When the registration start condition is satisfied, the vehicle parking assist apparatus 10 displays various images shown in FIG. 9A that includes the plane view image 51P, the parking area line image 52 (not shown in FIG. 9A), the setting button image 53, and the displacing button image 57 including button images 57U, 57L, 57R and 57D, on the display 50. When the parking lot 62 in which the vehicle 100 can be parked is present at the left side of the vehicle 100, the vehicle parking assist apparatus 10 displays the plane view image 51P on the display 50 such that a parking lot image is displayed at the left side of a vehicle image. On the other hand, when the parking lot 62 in which the vehicle 100 can be parked is present at the right side of the vehicle 100, the vehicle parking assist apparatus 10 displays the plane view image 51P on the display 50 such that the parking lot image is displayed at the right side of the vehicle image.

In addition, the vehicle parking assist apparatus 10 sets an area in which the vehicle 100 can be parked within the parking lot 62 as the parking area 61, based on the image information IMG and the sonar information SON. Then, the vehicle parking assist apparatus 10 displays the parking area line image 52 that represents the set parking area 61, on the display 50. The vehicle parking assist apparatus 10 uses, for example, the sonar information SON to acquire a size of the entrance 62ent of the parking lot 62.

The driver can displace the parking area line image 52 on the display 50 by applying the touch interaction to the displacing button image 57 before the driver applies the touch interaction to the setting button image 53. The driver can change a position of the parking area 61 to a position in which the driver desires to park the vehicle 100 by displacing the parking area line image 52 on the display 50.

When the driver applies the touch interaction to the setting button image 53, the vehicle parking assist apparatus 10 terminates displaying the setting button image 53 and the displacing button image 57 on the display 50. Instead, the apparatus 10 starts displaying the registration start button image 54 in an area in which the setting button image 53 has been displayed on the display 50, as shown in FIG. 9B.

In addition, when the driver applies the touch interaction to the setting button image 53, in other words, when the vehicle parking assist apparatus 10 receives a registration request for registering the parking area 61 in which the driver desires to park the vehicle 100, the vehicle parking assist apparatus 10 acquires the position of the parking area 61 corresponding to the position of the parking area line image 52 displayed on the display 50. Then, the vehicle parking assist apparatus 10 sets (determines) the parking area 61 corresponding to the parking area line image 52 displayed on the display 50 as a registration target parking area 61set.

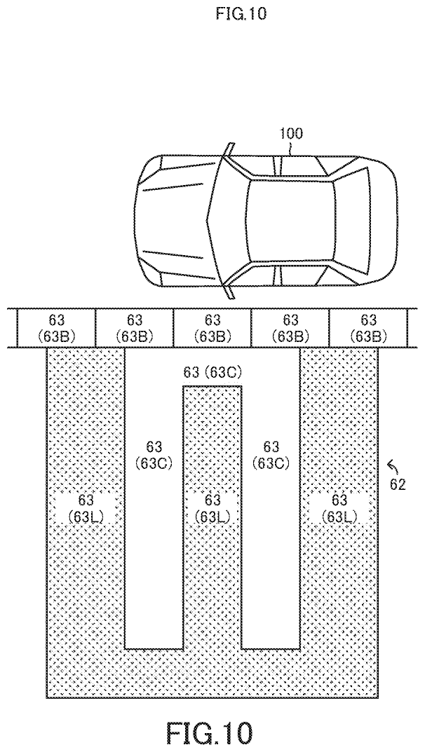

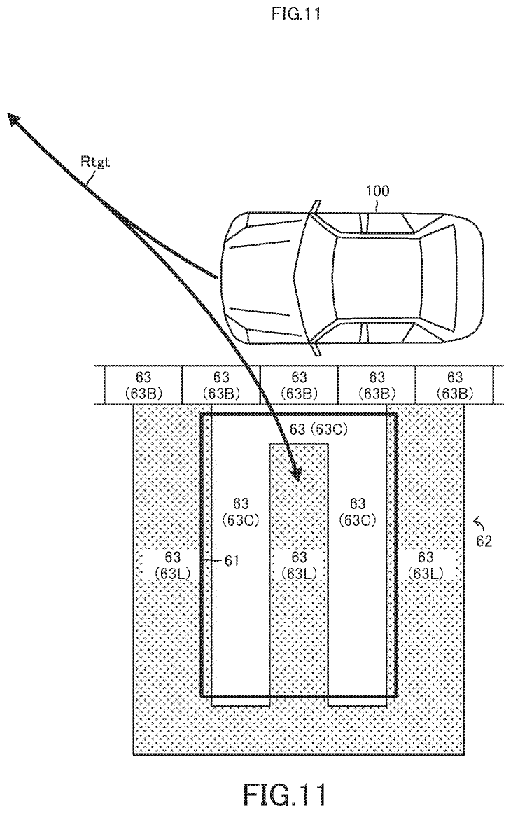

In addition, when the driver applies the touch interaction to the setting button image 53, the vehicle parking assist apparatus 10 sets/determines a target moving route Rtgt along which the vehicle 100 is to be moved to park the vehicle 100 into the registration target parking area 61set. For example, when the vehicle 100 stops at the right side of the non-registered parking lot 62 as shown in FIG. 10, the vehicle parking assist apparatus 10 sets/determines the target moving route Rtgt as shown in FIG. 11.

In addition, when the driver applies the touch interaction to the setting button image 53 while the vehicle has stopped at the right side of the parking lot 62, the vehicle parking assist apparatus 10 acquires a predetermined number of new left feature point(s) F3new in each of the four middle divided areas 73D5, the two front end divided areas 73D1, and the two rear end divided areas 73D2 of the left area 73. At this time, the vehicle parking assist apparatus 10 acquires the new left feature points F3new as the entrance feature points Fent. On the other hand, when the driver applies the touch interaction to the setting button image 53 while the vehicle has stopped at the left side of the parking lot 62, the vehicle parking assist apparatus 10 acquires the predetermined number of the new right feature point(s) F4new in each of the four middle divided areas 74D5, the two front end divided areas 74D1, and the two rear end divided areas 74D2 of the right area 74. At this time, the vehicle parking assist apparatus 10 acquires the new right feature points F4new as the entrance feature points Fent.

In this embodiment, when the driver applies the touch interaction to the setting button image 53 while the vehicle has stopped at the right side of the parking lot 62, the vehicle parking assist apparatus 10, the vehicle parking assist apparatus 10 acquires the entrance feature points Fent such that the number of the entrance feature points Fent acquired in each of the middle divided areas 73D5 is larger than the number of the entrance feature points Fent acquired in each of the front end divided areas 73D1 and the rear end divided areas 73D2. Basically, the vehicle parking assist apparatus 10 acquires the entrance feature points Fent such that the number of the entrance feature points Fent acquired in each of the areas 73D5 near a center of the entrance 62ent of the parking lot 62 is larger than the number of the entrance feature points Fent acquired in each of the areas 73D1 and 73D2 away from the center of the entrance 62ent of the parking lot 62.

On the other hand, when the driver applies the touch interaction to the setting button image 53 while the vehicle has stopped at the left side of the parking lot 62, the vehicle parking assist apparatus 10, the vehicle parking assist apparatus 10 acquires the entrance feature points Fent such that the number of the entrance feature points Fent acquired in each of the middle divided areas 74D5 is larger than the number of the entrance feature points Fent acquired in each of the front end divided areas 74D1 and the rear end divided areas 74D2. Basically, the vehicle parking assist apparatus 10 acquires the entrance feature points Fent such that the number of the entrance feature points Fent acquired in each of the areas 74D5 near the center of the entrance 62ent of the parking lot 62 is larger than the number of the entrance feature points Fent acquired in each of the areas 74D1 and 74D2 away from the center of the entrance 62ent of the parking lot 62.

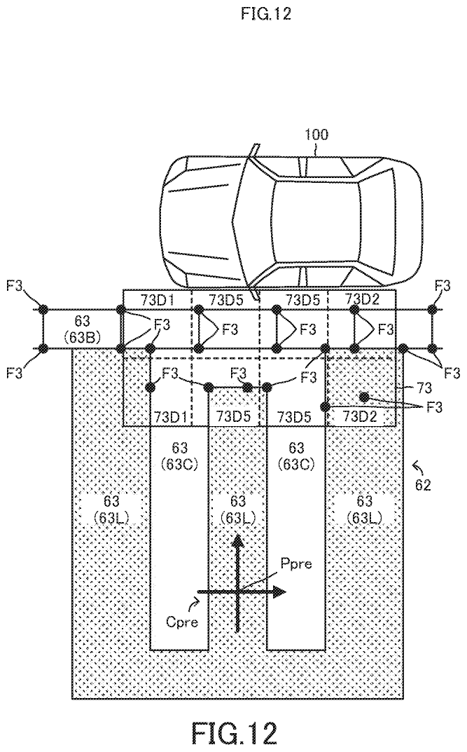

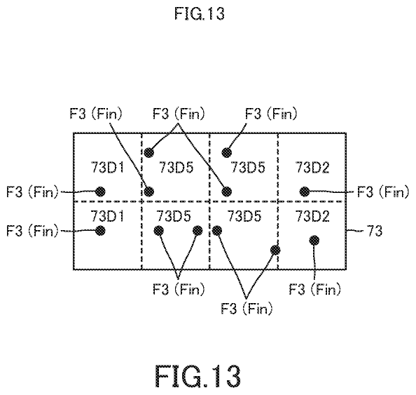

For example, when the vehicle 100 stops at the right side of the parking lot 62 as shown in FIG. 10, the vehicle parking assist apparatus 10 acquires (i) the two new left feature points F3new as the entrance feature points Fent from each of the four middle divided areas 7305 of the left area 73, (ii) the one new left feature point F3new as the entrance feature point Fent from each of the two front end divided areas 73D1 of the left area 73, and (iii) the one new left feature point F3new as the entrance feature point Fent from each of the two rear end divided areas 73D2 of the left area 73 (see FIG. 12 and FIG. 13). On the other hand, when the vehicle 100 stops at the left side of the parking lot 62, the vehicle parking assist apparatus 10 acquires (i) the two new right feature points F4new as the entrance feature points Fent from each of the four middle divided areas 74D5 of the right area 74, (ii) the one new left feature point F4new as the entrance feature point Fent from each of the two front end divided areas 74D1 of the right area 74, and (iii) the one new left feature point F4new as the entrance feature point Fent from each of the two rear end divided areas 74D2 of the right area 74.

It should be noted that the vehicle parking assist apparatus 10 may be configured to acquire the entrance feature points Fent such that the number of the entrance feature points Fent acquired from each of the two front end divided areas 73D1 and the two middle divided areas 73D5 adjacent to the front end divided areas 73D1 is larger than the number of the entrance feature points Fent acquired from each of the two rear end divided areas 73D2 and the two middle divided areas 73D5 adjacent to the rear end divided areas 73D2 when the driver tends to stop the vehicle 100 at the right side of the entrance 62ent of the parking lot 62 and slightly before a position immediately lateral to the entrance 62ent of the parking lot 62. Similarly, the vehicle parking assist apparatus 10 may be configured to acquire the entrance feature points Fent such that the number of the entrance feature points Fent acquired from each of the two front end divided areas 74D1 and the two middle divided areas 74D5 adjacent to the front end divided areas 74D1 is larger than the number of the entrance feature points Fent acquired from each of the two rear end divided areas 74D2 and the two middle divided areas 74D adjacent to the rear end divided areas 74D2 when the driver tends to stop the vehicle 100 at the left side of the entrance 62ent of the parking lot 62 and slightly before the position immediately lateral to the entrance 62ent of the parking lot 62.

When the vehicle parking assist apparatus 10 cannot acquire the predetermined number of the new left feature points F3new from at least one of the middle divided areas 73D5, the front end divided areas 73D1, and the rear end divided areas 73D2 of the left area 73, the vehicle parking assist apparatus 10 acquires the entrance feature points Fent from the remaining of the middle divided areas 73D5, the front end divided areas 73D1, and the rear end divided areas 73D2 to compensate a shortfall of the number of the acquired entrance feature points Fent. Similarly, when the vehicle parking assist apparatus 10 cannot acquire the predetermined number of the new right feature points F4new from at least one of the middle divided areas 74D5, the front end divided areas 74D1, and the rear end divided areas 74D2 of the right area 74, the vehicle parking assist apparatus 10 acquires the entrance feature points Fent from the remaining of the middle divided areas 7405, the front end divided areas 74D1, and the rear end divided areas 74D2 to compensate the shortfall of the number of the acquired entrance feature points Fent.

After the vehicle parking assist apparatus 10 acquires the entrance feature points Fent, the vehicle parking assist apparatus 10 acquires coordinates XY of each of the acquired entrance feature points Fent in a preliminary (tentative) coordinate system Cpre and stores the acquired coordinates XY as preliminary (tentative) entrance coordinates XYent_pre. In addition, the vehicle parking assist apparatus 10 acquires the luminance pattern information CT on each of the acquired entrance feature points Fent and stores the acquired luminance pattern information CT as preliminary (tentative) entrance luminance pattern information CTent_pre. The preliminary coordinate system Cpre is a coordinate system that has a predetermined point Ppre in the registration target parking area 61set as the origin. Therefore, the preliminary entrance coordinates XYent_pre indicates a position of the entrance feature point Fent relative to the predetermined position Ppre. The preliminary entrance information Ient_pre includes the preliminary entrance coordinates XYent_pre and the preliminary entrance luminance pattern information CTent_pre.

When the driver applies the touch interaction to the registration start button image 54, the vehicle parking assist apparatus 10 terminates displaying the registration start button image 54 on the display 50 but continues displaying the camera image 51C and the plane view image 51P on the display as shown in FIG. 9C. At this time point, if the parking lot 62 into which the vehicle 100 can be parked is present at the left side of the vehicle 100, the vehicle parking assist apparatus 10 acquires the image representing that parking lot 62 from the left camera 43 and displays the acquired image on the display 50 as the camera image 51C. In addition, the vehicle parking assist apparatus 10 displays the plane view image 51P on the display 50 such that the parking lot image is displayed at the left side of the vehicle image. Whereas, at this time point, if the parking lot 62 into which the vehicle 100 can be parked is present at the right side of the vehicle 100, the vehicle parking assist apparatus 10 acquires the image representing that parking lot 62 from the right camera 44 and displays the acquired image on the display 50 as the camera image 51C. In addition, the vehicle parking assist apparatus 10 displays the plane view image 51P on the display 50 such that the parking lot image is displayed at the right side of the vehicle image.

In addition, when the driver applies the touch interaction to the registration start button image 54, the vehicle parking assist apparatus 10 starts to execute the first parking moving process to move the vehicle 100 to the registration target parking area 61set along the target moving route Rtgt. The first parking moving process is a process to control the operations of the vehicle driving force generation apparatus 11, the brake apparatus 12, and the steering apparatus 13 in such a manner that the vehicle 100 moves along the target moving route Rtgt, based on (i) the image information IMG, (ii) the object information OBJ, (iii) the steering angle θst, (iv) the steering torque TQst, (v) the vehicle moving speed SPD, (vi) the vehicle yaw rate YR, (vii) the vehicle longitudinal acceleration Gx, and (viii) the vehicle lateral acceleration Gy.

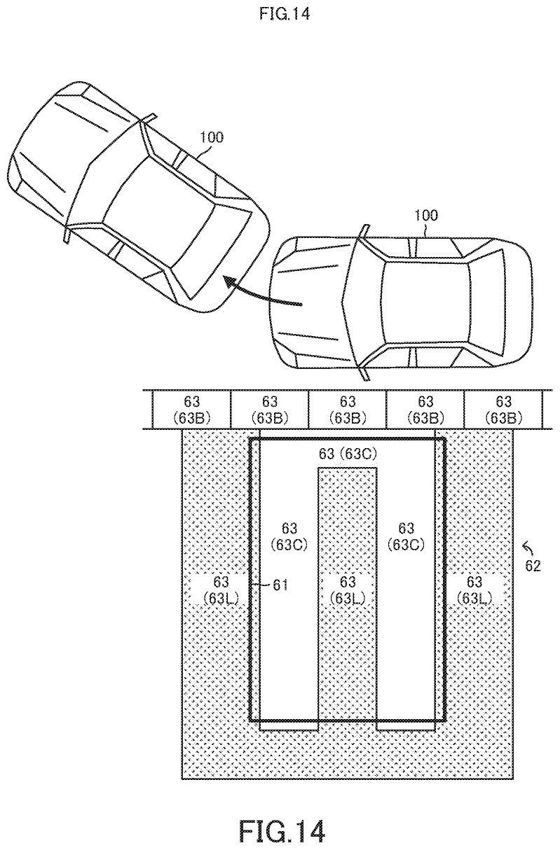

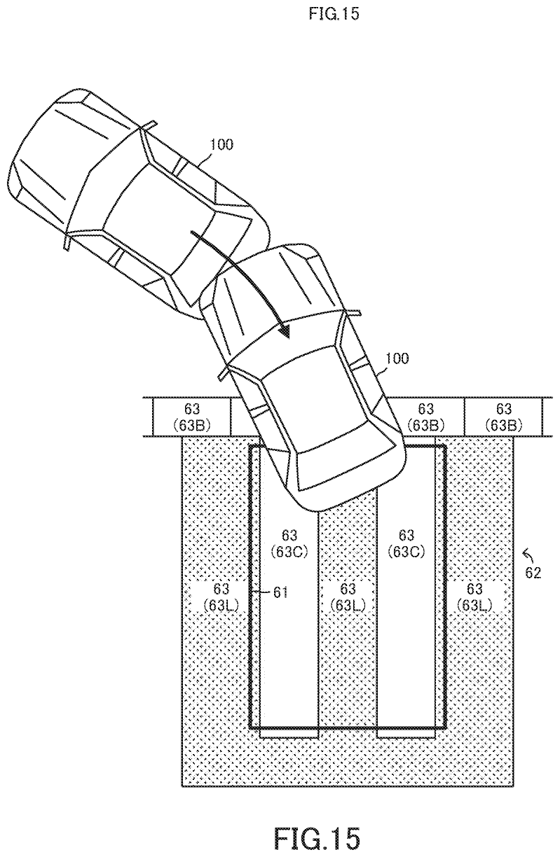

For example, when the vehicle 100 stops at the right side of the parking lot 62 into which the vehicle 100 can be parked as shown in FIG. 10, the vehicle parking assist apparatus 10 starts to execute the first parking moving process to move/turn the vehicle 100 forward right and then stops the vehicle 100, as shown in FIG. 14. Next, the vehicle parking assist apparatus 10 moves/turns the vehicle 100 rearward left as shown in FIG. 15.

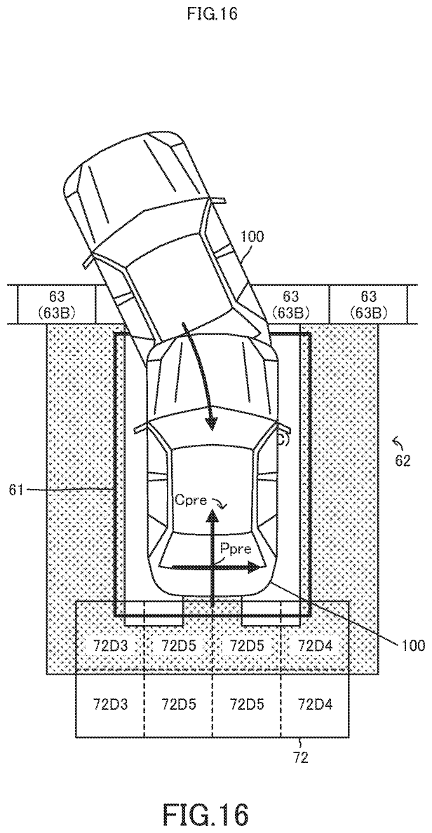

In this embodiment, the vehicle parking assist apparatus 10 acquires the rear feature points F2 as new rear feature points F2new when the vehicle parking assist apparatus 10 completes parking the vehicle 100 in the parking lot 62 after the moving direction of the vehicle 100 becomes straight while the parking assist apparatus 10 is letting the vehicle move backward through the parking assist control (see FIG. 16). It should be noted that the vehicle parking assist apparatus 10 may acquire the rear feature points F2 after the moving direction of the vehicle 100 becomes straight while the parking assist apparatus 10 is letting the vehicle move backward through the parking assist control but before the vehicle parking assist apparatus 10 completes parking the vehicle 100 in the parking lot 62. Alternatively, the vehicle parking assist apparatus 10 (i) may acquire the rear feature points F2 at a time point at which the moving direction of the vehicle 100 becomes straight, and (ii) may acquire the rear feature points F2 when the vehicle 100 moves the predetermined distance Dtravel_th backward after the moving direction of the vehicle 100 becomes straight while the parking assist apparatus 10 is letting the vehicle move backward. Further, the vehicle parking assist apparatus 10 may acquire not only the rear feature points F2 but also at least one of the front feature points F1, the left feature points F3, and the right feature points F4, when the apparatus 10 acquires the rear feature points F2.

Then, the vehicle parking assist apparatus 10 acquires one or more of the new rear feature points F2new from each of the rear divided areas 72D and sets the acquired new rear feature points F2new as midway feature points Fmid. Subsequently, the vehicle parking assist apparatus 10 acquires the coordinates XY of the acquired midway feature points Fmid in the preliminary (tentative) coordinate system Cpre and stores the acquired coordinates XY as preliminary midway coordinates XYmid_pre. In addition, the vehicle parking assist apparatus 10 acquires the luminance pattern information CT on the acquired midway feature points Fmid and stores the acquired luminance pattern information CT as preliminary midway luminance pattern information CTmid_pre. The preliminary midway coordinates XYmid_pre indicate positions of the midway feature points Fmid relative to the predetermined position Ppre. The preliminary midway information Imid_pre includes the preliminary midway coordinates XYmid_pre and the preliminary midway luminance pattern information CTmid_pre.

Further, while the vehicle parking assist apparatus 10 is executing the first parking moving process to move the vehicle 100 along the target moving route Rtgt, the vehicle parking assist apparatus 10 executes a safety determination process to determine whether or not the vehicle parking assist apparatus 10 can move the vehicle 100 safely to the registration target parking area 61set without having the vehicle 100 contact/collide with the object that is present in the parking lot 62. When the vehicle parking assist apparatus 10 determines that the vehicle parking assist apparatus 10 cannot move the vehicle 100 safely to the registration target parking area 61set, the vehicle parking assist apparatus 10 corrects the target moving route Rtgt such that the vehicle parking assist apparatus 10 can move the vehicle 100 safely to the registration target parking area 61set without having the vehicle 100 contact/collide with the object that is present in the parking lot 62. The vehicle parking assist apparatus 10 executes the safety determination process, based on the image information IMG and the object information OBJ that the vehicle parking assist apparatus 10 acquires during the execution of the first parking moving process.

In addition, while the vehicle parking assist apparatus 10 is executing the first parking moving process, the vehicle parking assist apparatus 10 executes a route determination/checking process. The route determination process is a process for determining whether or not the vehicle parking assist apparatus 10 can certainly park the vehicle 100 into the registration target parking area 61set, if the vehicle 100 is moved along the current target moving route Rtgt. When the vehicle parking assist apparatus 10 determines that the vehicle parking assist apparatus 10 cannot park the vehicle 100 into the registration target parking area 61set with the current target moving route Rtgt, the vehicle parking assist apparatus 10 corrects the current target moving route Rtgt such that the vehicle parking assist apparatus 10 can certainly park the vehicle 100 into the registration target parking area 61set. The vehicle parking assist apparatus 10 executes the route determination process, based on the image information IMG (in particular, the feature points F) that the vehicle parking assist apparatus 10 acquires during the execution of the first parking moving process.

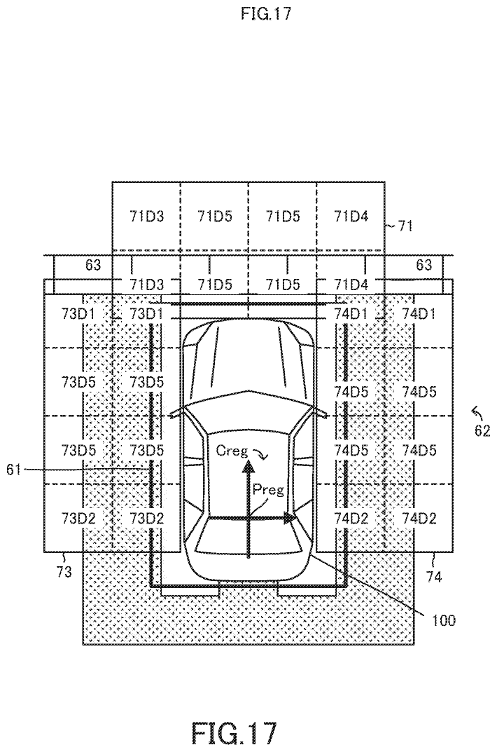

When the entire vehicle 100 has moved in the registration target parking area 61set (see FIG. 17), the vehicle parking assist apparatus 10 stops the vehicle 100 and terminates/finishes executing the first parking moving process. Thereby, parking the vehicle 100 in the parking lot 62 by the parking assist control is completed. At this time, the vehicle parking assist apparatus 10 acquires the front feature points F1, the left feature points F3, and the right feature points F4, as new front feature points F1new, new left feature points F3new, and new right feature points F4new, respectively. At this time, the vehicle parking assist apparatus 10 may acquire the rear feature points F2 as new rear feature points F2new.

Then, the vehicle parking assist apparatus 10 acquires one or more of the acquired new front feature points F1new from each of the front divided areas 71D as final feature points Ffin. In addition, the vehicle parking assist apparatus 10 acquires one or more of the acquired new left feature points F3new from each of the left divided areas 73D as the final feature points Ffin. In addition, the vehicle parking assist apparatus 10 acquires one or more of the acquired new right feature points F4new from each of the right divided areas 74D as the final feature points Ffin. If the vehicle parking assist apparatus 10 has acquired the new rear feature points F2new, the vehicle parking assist apparatus 10 acquires one or more of the acquired new rear feature points F2new from each of the rear divided areas 72D as the final feature points Ffin.

<Registration of Parking Lot Information>

When the vehicle parking assist apparatus 10 completes parking the vehicle 100 in the parking lot 62 through the parking assist control, the vehicle parking assist apparatus 10 displays the registering button image 55 on the display 50 as shown in FIG. 9D.

When the driver applies the touch interaction to the registering button image 55, the vehicle parking assist apparatus 10 acquires the coordinates XY of the acquired final feature points Ffin in a registration coordinate system Creg and registers or stores the acquired coordinates XY as registration inside coordinates XYin_reg. In addition, the vehicle parking assist apparatus 10 acquires the luminance pattern information CT of the acquired final feature points Ffin and registers or stores the acquired luminance pattern information CT as registration inside luminance pattern information CTin_reg. The registration coordinate system Creg is a coordinate system that has a predetermined point Preg as the origin (see FIG. 17). The vehicle 100 includes a shaft connecting a left rear wheel and a right rear wheel to each other. The predetermined point Preg is a center point of the shaft in the vehicle lateral direction Dy when parking the vehicle 100 in the registration target parking area 61set by the parking assist control is completed. Therefore, the registration inside coordinates XYin_reg indicate the positions of the final feature points Ffin relative to the predetermined position Preg.

In addition, the vehicle parking assist apparatus 10 converts the preliminary midway coordinates XYmid_pre to the coordinates XY in the registration coordinate system Creg and registers or stores the converted coordinates XY as the registration inside coordinates XYin_reg. In addition, the vehicle parking assist apparatus 10 registers or stores the preliminary midway luminance pattern information CTmid_pre as the registration inside luminance pattern information CTin_reg. Therefore, the registration inside coordinates XYin_reg indicate the positions of the midway feature points Fmid relative to the predetermined position Preg.

The registration inside information Iin_reg includes the registration inside coordinates XYin_reg and the registration inside luminance pattern information CTin_reg.

In addition, the vehicle parking assist apparatus 10 registers or stores the coordinate XY of the registration target parking area 61set in the registration coordinate system Creg as registration area coordinates XYarea_reg. The registration area coordinates XYarea_reg indicate the position of the parking area 61 relative to the predetermined position Preg. The registration area information Iarea_reg includes the registration area coordinates XYarea_reg

In addition, the vehicle parking assist apparatus 10 converts the preliminary entrance coordinates XYent_pre to the coordinates XY in the registration coordinate system Creg and registers or stores the converted coordinates XY as registration entrance coordinates XYent_reg. In addition, the vehicle parking assist apparatus 10 registers or stores the preliminary entrance luminance pattern information CTent_pre as the registered entrance luminance pattern information CTent_reg. Therefore, the registration entrance coordinates XYent_reg indicate the positions of the entrance feature points Fent relative to the predetermined position Preg. The registration entrance information Ient_reg includes the registration entrance coordinates XYent_reg and the registered entrance luminance pattern information CTent_reg.

As described above, the parking lot information Ipark includes the registration entrance information Ient_reg, the registration inside information Iin_reg, and the registration area information Iarea_reg.

<Parking Vehicle in Registered Parking Lot>

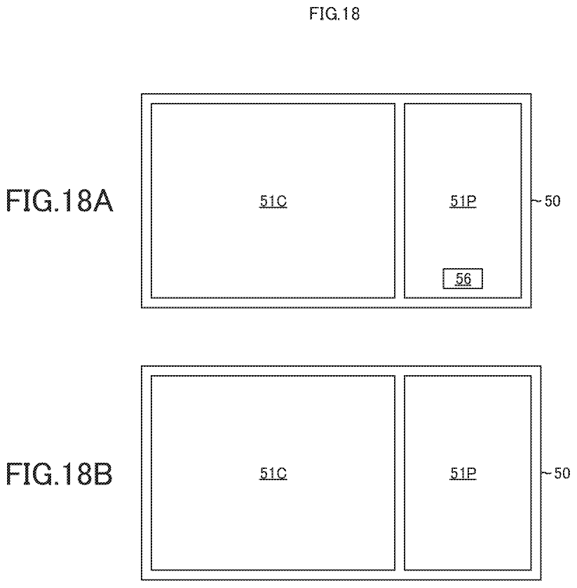

When an autonomous parking start condition is satisfied, the vehicle parking assist apparatus 10 displays the camera image 51C, the plane view image 51P, the parking area line image 52 (not shown), and the parking start button image 56 on the display 50 as shown in FIG. 18A. The autonomous parking start condition is satisfied when (i) the vehicle parking assist apparatus 10 determines that the vehicle 100 has stopped by the entrance 62ent of the parking lot 62, (ii) the vehicle parking assist apparatus 10 determines that the parking lot 62 in question is the registered parking lot, and (iii) the driver applies the touch interaction to the parking assist switch 48. In this regard, when the registered parking lot 62 is present at the left side of the vehicle 100, the vehicle parking assist apparatus 10 acquires the image representing the registered parking lot 62 from the left camera 43 and displays the acquired image on the display 50 as the camera image 51C. In addition, the vehicle parking assist apparatus 10 displays the plane view image 51P on the display 50 such that the parking lot image is displayed at the left side of the vehicle image. On the other hand, when the registered parking lot 62 is present at the right side of the vehicle 100, the vehicle parking assist apparatus 10 acquires the image representing the registered parking lot 62 from the right camera 44 and displays the acquired image on the display 50 as the camera image 51C. In addition, the vehicle parking assist apparatus 10 displays the plane view image 51P on the display 50 such that the parking lot image is displayed at the right side of the vehicle image.

In addition, the vehicle parking assist apparatus 10 fixes the position of the parking area 61, based on the registration area coordinates XYarea_reg included in the parking lot information Ipark relating to the registered parking lot 62 in which the vehicle parking assist apparatus 10 will park the vehicle 100 this time. The vehicle parking assist apparatus 10 displays an image representing that parking area 61 whose position is fixed as the parking area line image 52 on the display 50.

When the driver applies the touch interaction to the parking start button image 56, the vehicle parking assist apparatus 10 terminates displaying the parking start button image 56 on the display 50 and continues displaying the camera image 51C and the plane view image 51P on the display 50 as shown in FIG. 18B.

In addition, when the driver applies the touch interaction to the parking start button image 56, the vehicle parking assist apparatus 10 sets a target parking area 61tgt to the parking area 61 which corresponds to the position of the parking area line image 52 displayed on the display 50.

In addition, when the driver applies the touch interaction to the parking start button image 56, the vehicle parking assist apparatus 10 sets the target moving route Rtgt along which the vehicle parking assist apparatus 10 moves the vehicle 100 to park the vehicle 100 in the target parking area 61tgt.

Then, the vehicle parking assist apparatus 10 executes a second parking moving process to move the vehicle 100 to the target parking area 61tgt along the target moving route Rtgt. The second parking moving process is a process to control the operations of the vehicle driving force generation apparatus 11, the brake apparatus 12, and the steering apparatus 13 to move the vehicle 100 along the target moving route Rtgt, based on (i) the image information IMG, (ii) the object information OBJ, (iii) the steering angle θst, (iv) the steering torque TQst, (v) the vehicle moving speed SPD, (vi) the vehicle yaw rate YR, (vii) the vehicle longitudinal acceleration Gx, and (viii) the vehicle lateral acceleration Gy.

While the vehicle parking assist apparatus 10 is executing the second parking moving process to move the vehicle 100 along the target moving route Rtgt, the vehicle parking assist apparatus 10 executes a safety determination process to determine whether or not the vehicle parking assist apparatus 10 can move the vehicle 100 safely to the target parking area 61tgt, preventing the vehicle 100 from contacting to the object in the parking lot 62. When the vehicle parking assist apparatus 10 determines that the vehicle parking assist apparatus 10 cannot move the vehicle 100 safely to the target parking area 61tgt, the vehicle parking assist apparatus 10 corrects the target moving route Rtgt such that the vehicle parking assist apparatus 10 can move the vehicle 100 safely to the target parking area 61tgt, preventing the vehicle 100 from contacting to the object in the parking lot 62. The vehicle parking assist apparatus 10 executes the safety determination process, based on the image information IMG and the object information OBJ which the vehicle parking assist apparatus 10 acquires during the execution of the second parking moving process.

While the vehicle parking assist apparatus 10 is executing the second parking moving process, the vehicle parking assist apparatus 10 executes a parking position determination process. The parking position determination process includes the following steps.

A step of searching the camera image to find out image parts having the same luminance patterns as the luminance patterns of the registered entrance luminance pattern information CTent_reg or the registration inside luminance pattern information CTin_reg.

A step of determining whether or not the position of the target parking area 61tgt in the parking lot 62 matches with the position indicted by the registration area coordinates XYarea_reg based on the position relationship between the coordinates XY of the found image parts and the registration area coordinates XYarea_reg.

When the vehicle parking assist apparatus 10 does not determines that the position of the target parking area 61tgt in the parking lot 62 matches with the position indicted by the registration area coordinates XYarea_reg, the vehicle parking assist apparatus 10 corrects the position of the target parking area 61tgt such that the position of the target parking area 61tgt matches with the position indicted by the registration area coordinates XYarea_reg, and corrects the target moving route Rtgt such that the vehicle parking assist apparatus 10 can move the vehicle 100 to the corrected target parking area 61tgt.

When the entire vehicle 100 has moved in the target parking area 61tgt, the vehicle parking assist apparatus 10 stops the vehicle 100 and terminates executing the second parking moving process. Thereby, parking the vehicle 100 in the parking lot 62 by the parking assist control is completed.

<Summary of Operations of Vehicle Parking Assist Apparatus>

The image of the object is easily affected by change of the situation/state surrounding the vehicle and the parking lot between the time point at which the parking lot information Ipark is registered/memorized and the time point thereafter. For example, the position of the object may change between the time point at which the parking lot information Ipark is registered/memorized and the time point thereafter. In addition, the image of the object may vary, if the shooting position of the camera vary between the time point at which the parking lot information Ipark is registered/memorized and the time point thereafter. Therefore, the vehicle parking assist apparatus 10 specifies an object image Pobj in the camera image, and excludes (masks) the specified object image Pobj from the camera image so as to acquire the excluded camera image. When the parking lot information Ipark is registered, the vehicle parking assist apparatus 10 acquires the feature points F from the excluded camera image. After the parking lot information Ipark was registered, the vehicle parking assist apparatus 10 searches the excluded camera image to find out image parts having the same luminance patterns as the luminance patterns of registered entrance luminance pattern information CTent_reg.

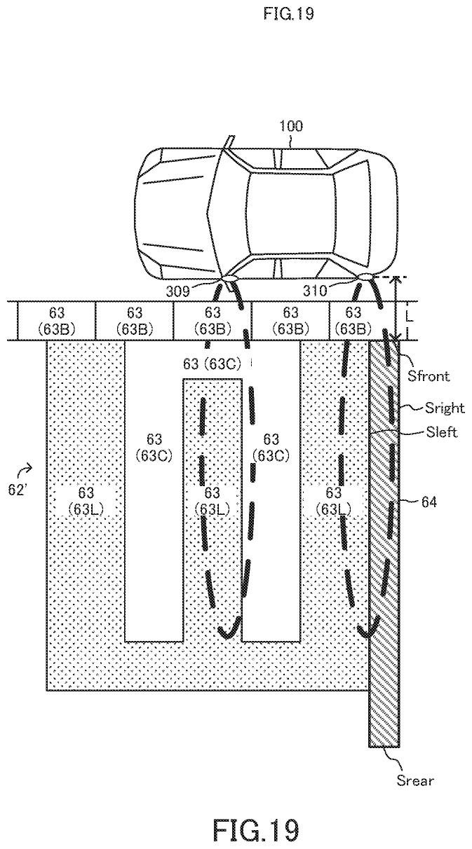

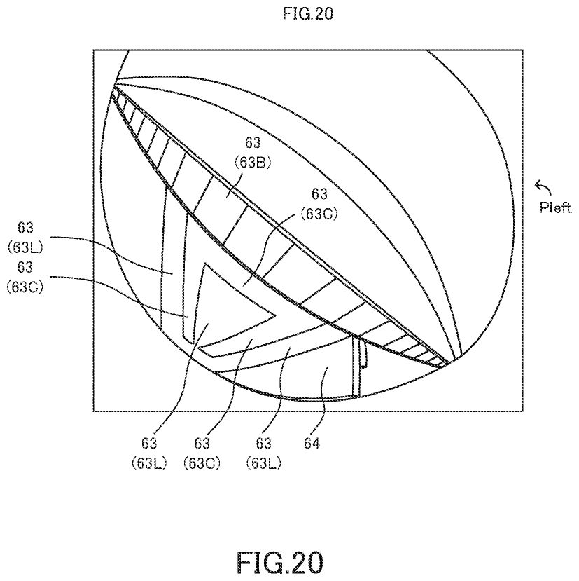

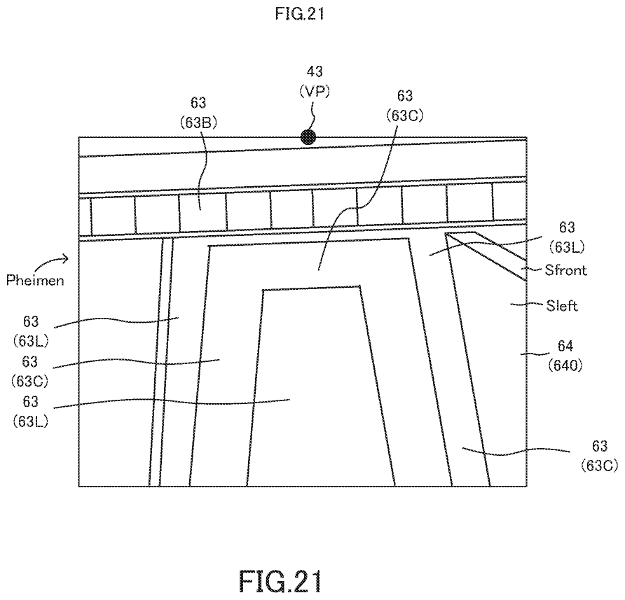

A parking lot 62′ shown in FIG. 19 is different from the parking lot 62 shown in FIG. 4 in that a wall 64 that is the object is present at the right side of the parking lot 62′. A left camera image Pleft shown in FIG. 20 is an image that the left camera 43 has taken when the vehicle has stopped in the vicinity of the entrance 62′ent of the parking lot 62′. The vehicle parking assist apparatus 10 acquires a left plane view image Pheimen shown in FIG. 21 by converting the left camera image Pleft into an image in a plane view. In other words, the left plane view image Pheimen is generated such that the left camera image Pleft is viewed from a left camera upward viewpoint VP positioned vertically above the left camera 43.

If the left plane view image Pheimen is generated such that the left camera image Pleft is viewed from a viewpoint positioned vertically above the wall 64, only an image of an upper surface of the wall 64 is included in that left plane view image Pheimen as an image representing the wall 64. However, as described above, the left plane view image Pheimen is generated such that the left camera image Pleft is viewed from the left camera upward viewpoint VP. Therefore, as shown in FIG. 21, an image 640 of the wall 64 (an object image) in the left plane view image Pheimen includes an image corresponding to a front surface Sfront of the wall 64 and an image corresponding to a left side surface Sleft of the wall 64.

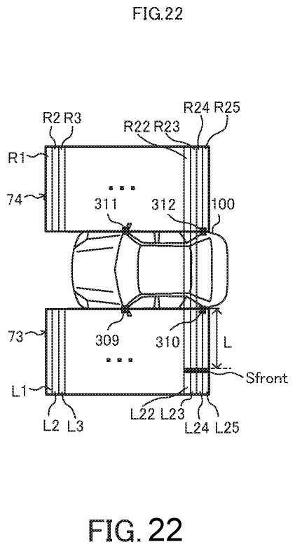

The vehicle parking assist apparatus 10 specifies a position of the object around the vehicle 100 based on the sonar information SON. In an example shown in FIG. 19, the tenth clearance sonar 310 detects a distance L between the front surface Sfront and the tenth clearance sonar 310. The vehicle parking assist apparatus 10 recognizes/determines that, based on the sonar information SON obtained from the tenth clearance sonar 310, the object (the front surface Sfront of the wall 64) is present at a point away from the left side of the vehicle 100 by the distance L in areas L22 to L25 shown in FIG. 22. It should be noted that the vehicle parking assist apparatus 10 divides each of the left side area 73 and the right side area 74 into twenty five areas. The twenty five areas of the left side area 73 are referred to as “areas L1 to L25”, respectively. The twenty five areas of the right side area 74 are referred to as “areas R1 to R25”, respectively. The vehicle parking assist apparatus 10 divides each of the front area 71 and the rear area 72 into twenty five areas. Each of the divided area of the front area 71 and the rear area 72 has a rectangular shape having a long side in the longitudinal direction.

The vehicle parking assist apparatus 10 detects only a reflecting surface of the object that reflects the sonic waves radiated by the clearance sonars. In the example shown in FIG. 21, the vehicle parking assist apparatus 10 detects only the front surface of the wall 64. In other words, the vehicle parking assist apparatus 10 cannot detect a shape of the object behind the reflecting surface with respect to the clearance sonar.

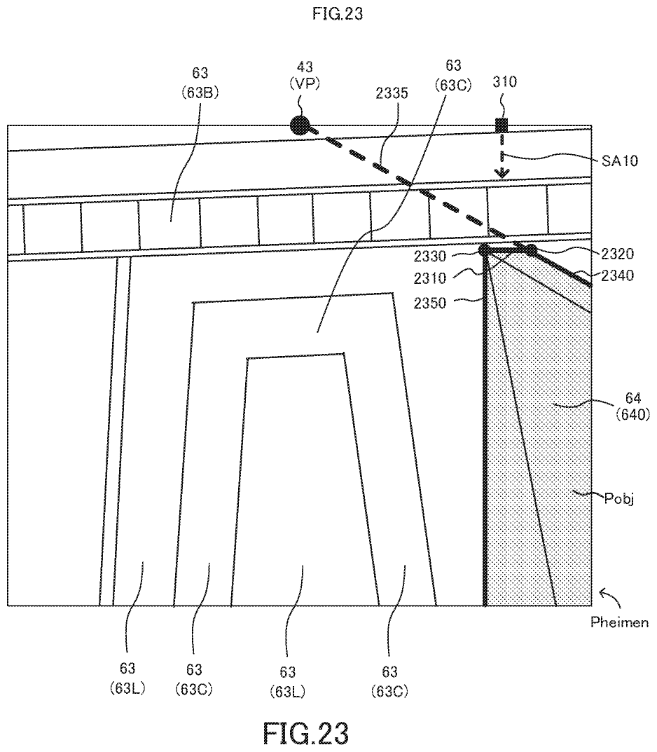

As shown in FIG. 23, the vehicle parking assist apparatus 10 plots, on the left plane view image Pheimen, the positions (a sonar detection results 2310) of the object (the front surface Sfront of the wall 64) detected based on the sonar information SON at positions away from tenth clearance sonar 310 by the distance detected by the tenth clearance sonar 310.

The vehicle parking assist apparatus 10 specifies the object image Pobj in the left plane view image Pheimen based on the sonar detection results 2310 that are plotted on the left plane view image Pheimen.

More specifically, first, the vehicle parking assist apparatus 10 acquires a furthest point 2320 and a closest point 2330 using the sonar detection results 2310. The furthest point 2320 is a point that is the furthest from left camera 43 among the sonar detection results 2310. The furthest point 2320 is a point that is the closest to the left camera 43 among the sonar detection results 2310. Next, the vehicle parking assist apparatus 10 acquires a gradient of a virtual line segment 2335 from the furthest point 2320 to the left camera 43. Then, the vehicle parking assist apparatus 10 acquires a first virtual line 2340 which extends from the furthest point 2320 in a direction having the gradient GR and away from the left camera 43.

The vehicle parking assist apparatus 10 acquires a second virtual line 2350 that extends from the closest point 2330 in a direction parallel with the center axis SA10 of the radiation range of the sonic waves of the tenth clearance sonar 310 and away from the left camera 43. It should be noted that the second virtual line 2350 extends in a direction orthogonal to the left surface of the vehicle 100 (i.e., in the vehicle width direction Dy). Because the direction of the center axis SA10 is the direction orthogonal to the left surface of the vehicle 100 (i.e., the vehicle width direction Dy).

Thereafter, the vehicle parking assist apparatus 10 specifies, as the object image Pobj, an image of an area which is defined by the sonar detection results 2310, the first virtual line segment 2340, and the second virtual line 2350.

The reason why the vehicle parking assist apparatus 10 uses the first virtual line 2340 to define the object image Pobj is that a line image representing the object's height at the furthest point 2320 in the plane view image Pheimen inclines (leans) to the direction away from the left camera 43 by the gradient GR. Accordingly, the object image Pobj covers an object that is preset behind the front surface Sfront from the image, it is possible to exclude the image representing the object from the excluded camera image.

If another object is present behind the reflecting surface that reflects the sonic waves from the clearance sonar, the clearance sonar cannot detect that another object. Because the sonic waves from the clearance sonar does not reach that another object, and thus, that another object does not reflect the sonic waves. Therefore, there may be another object in the area behind the reflecting surface. In view of this, the vehicle parking assist apparatus 10 uses the second virtual line 2350 to define the object image Pobj, so that the object image Pobj can include the area where that another object may or may not be present. Accordingly, the vehicle parking assist apparatus 10 can certainly prevent the apparatus 10 from acquiring the feature points F based on the image that may include a part representing an object. The center axis CA3 of the shooting area of the left camera 43 coincides with the center axis SA9 of the ninth clearance sonar 309 and the center axis SA10 of the tenth clearance sonar 310. Accordingly, a line image representing the object's height at the closest point 2330 does not protrude from the second virtual line 2350 so as to be able to be included in the object image Pobj. Therefore, the object image Pobj covers an object that is preset behind the front surface Sfront from the image, it is possible to exclude the image representing the object from the excluded camera image.

Finally, the vehicle parking assist apparatus 10 acquires the feature points F from a masked/excluded image that does not include the object image Pobj in the left plane view image Pheimen. The masked image is an image that the vehicle parking assist apparatus 10 generates by excluding the object Pobj from the left plane view image Pheimen (i.e., the left plane view image Pheimen in which the object Pobj is masked).

As described above, the vehicle parking assist apparatus 10 masks the object image Pobj from the plane view image Pheimen into which a registration image is converted so as to obtain the masked image. The registration image is taken by each of the left camera 43 and the right camera 44 when the parking lot information Ipark is registered. The vehicle parking assist apparatus 10 acquires the feature points F from the masked image. The masked image is an image including only image representing the surface of the ground. The registered entrance luminance pattern information CTent_reg acquired based on the thus acquired feature points F is registered/memorized as the registration entrance information Ient_reg. Accordingly, even if the situation/state surrounding the vehicle 100 and the parking lot 62 changes after the parking lot information Ipark is registered, the vehicle parking assist apparatus 10 can determine correctly whether the vehicle 100 has stopped at the right side or the left side of the registered parking lot 62 whose parking lot information Ipark has been already registered, because the luminance pattern information CT of the feature points F acquired from the masked image is registered as the registration entrance information Ient_reg.

The vehicle parking assist apparatus 10 masks the object image Pobj from the plane view image Pheimen into which the post registration image is converted. The post registration image is taken by each of the cameras 45 after the parking lot information Ipark has been registered. The vehicle parking assist apparatus 10 searches the masked image to find out the image parts having the substantially same luminance patterns as the luminance patterns of the registered entrance luminance pattern information CTent_reg. Therefore, even if the situation surrounding the vehicle 100 and the parking lot 62 changes after the time of the parking lot information Ipark has been registered, the vehicle parking assist apparatus 10 can determine correctly whether the vehicle 100 has stopped at the right side or the left side of the registered parking lot 62 whose parking lot information Ipark has been already registered.

It should be noted that the vehicle parking assist apparatus 10 specifies the object image Pobj in the plane view image Pheimen into which the camera image taken by the right camera 44 is converted, when the object is present at the right side of the vehicle 100. The process for specifying the object image Pobj is as described above.

The vehicle parking assist apparatus 10 specifies the object image Pobj in the plane view image Pheimen into which the camera image taken by the front camera 41 is converted, when the object is present at the front side of the vehicle 100. In this case, the second virtual line 2350 extends from the closest point 2330 in the same direction as directions of the center axis SA2 of the second clearance sonar 302 and the center axis SA4 of the fourth clearance sonar 304. The direction is a direction away from the front camera 41.

When the first clearance sonar 301 or the third clearance sonar 303 detects the object, the vehicle parking assist apparatus 10 may not mask the line image representing the object's height at the closest point 2330, if the second virtual line 2350 extends in the same direction as the center axis SA1 of the first clearance sonar 301 or the center axis SA3 of the third clearance sonar 303 (in other words, if the second virtual line 2350 extends in a direction that is tilted 45 degrees leftward or rightward with respect to the vehicle longitudinal direction Dx). Therefore, even if the first clearance sonar 301 or the third clearance sonar 303 detects the object, the vehicle parking assist apparatus 10 extends the second virtual line 2350 from the closest point 2330 in the same direction as directions of the center axis SA2 of the second clearance sonar 302 and the center axis SA4 of the fourth clearance sonar 304 (in other words, the vehicle longitudinal direction Dx). The direction is a direction away from the front camera 41. The direction of the center axis CA1 of the shooting area of the front camera 41 is the vehicle longitudinal direction Dx. Therefore, the vehicle parking assist apparatus 10 extends the second virtual line 2350 in the vehicle longitudinal direction Dx to be able to include the line image representing the object's height at the closest point 2330 in the object image Pobj. Further, the vehicle parking assist apparatus 10 can include the image representing the area where the clearance sonars cannot detect the other object due to the object in the object image Pobj.

It should be noted that the vehicle parking assist apparatus 10 specifies the object image Pobj in the plane view image Pheimen into which the camera image taken by the rear camera 42 is converted, when the object is present at the rear side of the vehicle 100. The process for specifying the object image Pobj is the same as process executed when the object is present at the front side of the vehicle 100.

<Specific Operations of Vehicle Parking Assist Apparatus>

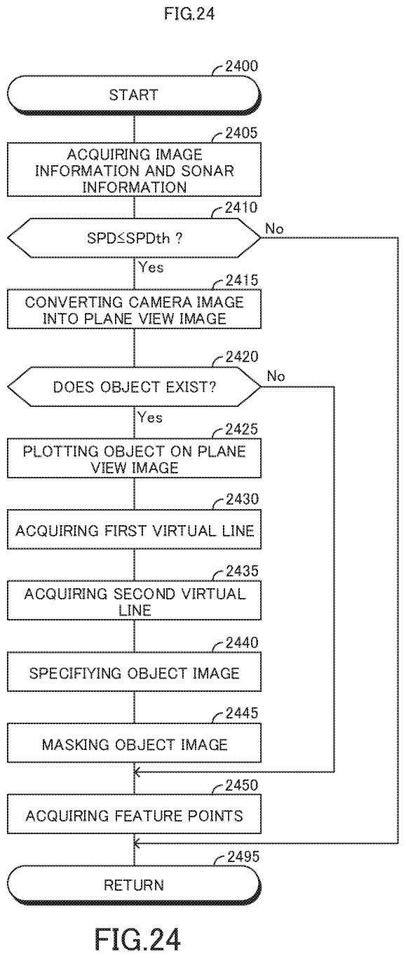

Next, specific operations of the vehicle parking assist apparatus 10 will be described. The CPU of the ECU 90 of the vehicle parking assist apparatus 10 is configured or programmed to execute a routine shown in FIG. 24 each time a predetermined time elapses.

When an appropriate time point comes, the CPU starts processing from step 2400, and proceeds to step 2405 so as to acquire the image information from the camera sensor apparatus 40, and the sonar information SON from the sonar sensor apparatus 30. The CPU proceeds to Step 2410.

At Step 2410, the CPU determines whether or not the low speed condition that the vehicle speed SPD is equal to or lower than the threshold speed SPDth is satisfied. If the low speed condition is satisfied, the CPU makes a “Yes” determination at Step 2410, and proceeds to Step 2415. At Step 2415, the CPU converts the camera image taken by each of the cameras 45 into the plane view image, and proceeds to Step 2420.

At Step 2420, the CPU determines whether or not the object is present based on the sonar information SON. If at least one of the first clearance sonar 301 to the fourth clearance sonar 304 detects the object, the CPU determines that the object is present in the shooting area of the front camera 41. If at least one of the fifth clearance sonar 305 to the eighth clearance sonar 308 detects the object, the CPU determines that the object is present in the shooting area of the rear camera 41. If at least one of the ninth clearance sonar 309 and the tenth clearance sonar 310 detects the object, the CPU determines that the object is present in the shooting area of the left camera 41. If at least one of the eleventh clearance sonar 311 and the twelfth clearance sonar 312 detects the object, the CPU determines that the object is present in the shooting area of the right camera 41.

If the object is present, the CPU makes a “Yes” determination at Step 2420, and executes Steps 2425 to 2450. Thereafter, the CPU proceeds to Step 2495 so as to end the present routine tentatively.

Step 2425: The CPU plots the sonar detection results on the plane view images. Each of a length in a longitudinal direction and a length in a width direction of a pixel of the plane view image corresponds to a predetermined actual length (e.g., approximately 15 cm). The CPU specifies pixels of the object in the plane view image based on the lengths of the pixel, the position of the clearance sonar which detects the object, and the distance between the clearance sonar and the object. The CPU plots the sonar detection results in the specified the pixels.

Step 2430: The CPU acquires the first virtual line which extends from the furthest point included in the sonar detection results with respect to the camera.

Step 2435: The CPU acquires the second virtual line which extends from the closest point included in the sonar detection results with respect to the camera.

Step 2440: The CPU specifies, as the object image, an image of an area which is defined/surrounded by the sonar detection results, the first virtual line, and the second virtual line as the object image.

Step 2445: The CPU acquires the masked image by masking the object image in the plane view image.

Step 2450: The CPU acquires the feature points F from the masked image.

If the vehicle speed SPD is higher than the threshold speed SPDth when the CPU proceeds to Step 2410, the CPU makes a “No” determination at Step 2410, and proceeds to Step 2495 so as to end the present routine tentatively.

If the object is not present when the CPU proceeds to Step 2420, the CPU makes a “Yes” determination at Step 2420, and proceeds to Step 2450 so as to acquire the feature points F (from the plane view image).

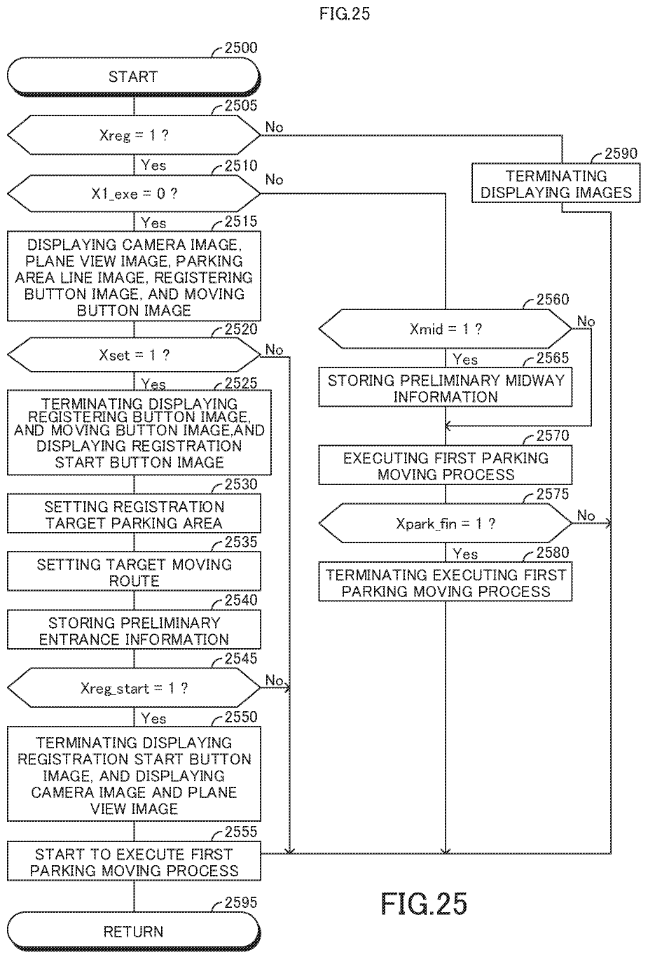

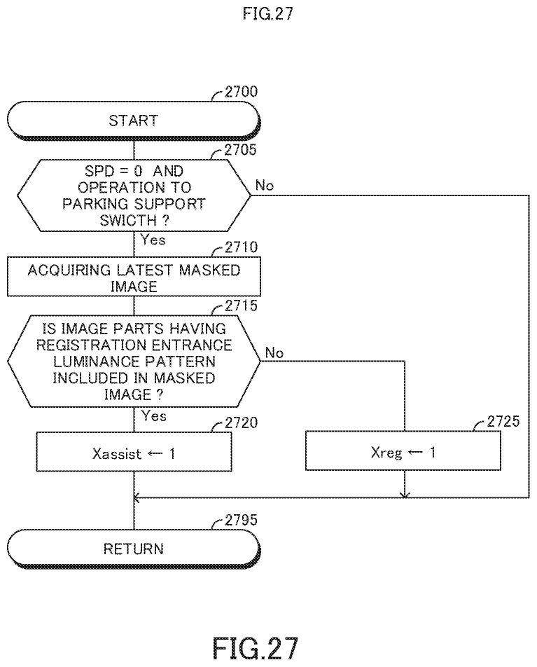

The CPU is configured or programmed to execute a routine shown in FIG. 25 each time a predetermined time elapses. When an appropriate time point comes, the CPU starts processing from step 2500, and proceeds to step 2505 so as to determine whether or not a value of a registration flag Xreg is “1”. The value of the registration flag Xreg is set to “1” when the registration start condition is satisfied (at Step 2727 shown in FIG. 27). The value of the registration flag Xreg is set to “0” when the parking of the vehicle 100 into the parking lot 62 is completed.

When the CPU makes a “Yes” determination at Step 2505, the CPU proceeds to Step 2510 so as to determine whether or not a value of the first parking moving process flag X1_exe is “0”. The value of the first parking moving process flag X1_exe is set to “1” when the execution of the first parking moving process is started. The value of the first parking moving process flag X1_exe is set to “0” when the execution of the first parking moving process is ended.

When the CPU makes a “Yes” determination at Step 2510, the CPU proceeds to Step 2515 so as to display the plane view image 51P, the parking area line image 52, the setting button image 53, and the displacing button image 57 on the display 50.

Next, the CPU proceeds to a step 2520 so as to determine whether or not a value of a setting completed flag Xset is “1.” The value of the setting completed flag Xset is set to “1” when the touch interaction is applied to the setting button image 53. The value of the setting completed flag Xset is set to “0” when the execution of the first parking moving process is started.

When the CPU makes a “Yes” determination at Step 2520, the CPU proceeds to Step 2525 so as to terminate displaying the setting button image 53, and the displacing button image 57 on the display 50 and display the registration start button image 54 on the display 50. Next, the CPU proceeds to Step 2530 so as to set the parking area 61 corresponding to the parking area line image 52 as the registration target parking area 61set. Next, the CPU proceeds to Step 2535 so as to set the target moving route Rtgt to a moving route of the vehicle 100 to the registration target parking area 61set. Next, the CPU proceeds to Step 2540 so as to acquire the preliminary entrance information Ient_pre as described above and register/memorize or store the acquired preliminary entrance information Ient_pre in the RAM. It should be noted that the preliminary entrance coordinates XYent_pre and the preliminary entrance luminance pattern information CTent_pre included in the preliminary entrance information Ient_pre are acquired based on the feature points F acquired at Step 2450 of the routine shown in FIG. 24 which is executed just before the present time point.

Next, the CPU proceeds to Step 2545 so as to determine whether or not a value of a registration start flag Xreg_start is “1.” The value of the registration start flag Xreg_start is set to “1” when the touch interaction is applied to the registration start button image 54. On the other hand, the value of the registration start flag Xreg_start is set to “0” when the execution of the first parking moving process is started.

When the CPU makes a “Yes” determination at Step 2545, the CPU proceeds to Step 2550 so as to terminate displaying the registration start button image 54 on the display 50 and display the camera image 51C and the plane view image 51P on the display 50. Next, the CPU proceeds to Step 2555 so as to start to execute the first parking moving process to move the vehicle 100 to the registration target parking area 61set along the target moving route Rtgt. Next, the CPU proceeds to Step 2595 so as to end the present routine tentatively.

On the other hand, when the CPU makes a “No” determination at Step 2545, the CPU proceeds to Step 2595 so as to end the present routine tentatively.

Also, when the CPU makes a “No” determination at Step 2520, the CPU proceeds to Step 2595 so as to end the present routine tentatively.

When the CPU makes a “No” determination at Step 2510, the CPU proceeds to Step 2560 to determine whether or not a value of a midway information acquiring flag Xmid is “1.” The value of the midway information acquiring flag Xmid is set to “1” when the CPU predicts that the vehicle 100 continues moving rearward straight without turning until the CPU completes parking the vehicle 100 into the parking lot 62 by the parking assist control. On the other hand, the value of the midway information acquiring flag Xmid is set to “0” when an execution of a process of Step 2565 is completed.

When the CPU makes a “Yes” determination at Step 2560, the CPU proceeds to Step 2565 so as to acquire the preliminary midway information Imid_pre as described above and register/memorize or store the acquired preliminary midway information Imid_pre in the RAM. Next, the CPU proceeds to Step 2570. It should be noted that the preliminary midway coordinates XYmid_pre and the preliminary midway luminance pattern information CTmid_pre included in the preliminary midway information Imid_pre are acquired based on the feature points F acquired at Step 2450 of the routine shown in FIG. 24 which is executed just before the present time point.

On the other hand, when the CPU makes a “No” determination at Step 2560, the CPU proceeds to a step 2570.

When the CPU proceeds to Step 2570, the CPU continues executing the first parking moving process. Next, the CPU proceeds to Step 2575 to determine whether or not a value of a parking completed flag Xpark_fin is “1”. The value of the parking completed flag Xpark_fin is set to “1” when the entire vehicle 100 has moved in the registration target parking area 61set. On the other hand, the value of the parking completed flag Xpark_fin is set to “0” when the execution of the first parking moving process is completed.

When the CPU makes a “Yes” determination at Step 2575, the CPU proceeds to Step 2580 so as to terminate executing the first parking moving process. Next, the CPU proceeds to Step 2595 so as to end the present routine tentatively.

On the other hand, when the CPU makes a “No” determination at Step 2575, the CPU proceeds to Step 2595 so as to end the present routine tentatively.

When the CPU makes a “No” determination at Step 2505, the CPU proceeds to Step 2590 to terminate displaying the plane view image 51P, etc. on the display 50. Next, the CPU proceeds to Step 2595 to end the present routine tentatively.

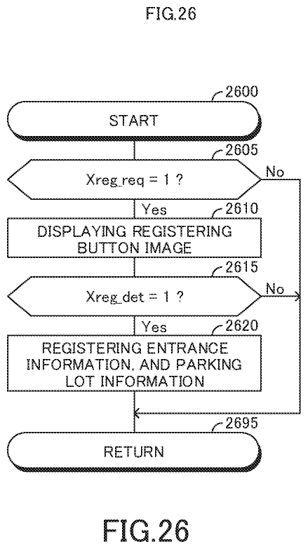

In addition, the CPU is configured or programmed to execute a routine shown in FIG. 26 each time the predetermined time elapses. When an appropriate time point comes, the CPU starts processing from Step 2600 shown in FIG. 26, and proceeds to Step 2605 so as to determine whether or not a value of an information registration request flag Xreg_req is “1.” The value of the information registration request flag Xreg_req is set to “1” when parking the vehicle 100 in the parking lot 62 by the first parking moving process is completed. On the other hand, the value of the information registration request flag Xreg_req is set to “0” when the parking lot information Ipark is registered in the RAM.

When the CPU makes a “Yes” determination at Step 2605, the CPU proceeds to Step 2610 to display the registering button image 55 on the display 50. Next, the CPU proceeds to Step 2615 so as to determine whether or not a value of a registration fixed flag Xreg_det is “1.” The value of the registration fixed flag Xreg_det is set to “1” when the touch interaction is applied to the registering button image 55. On the other hand, the value of the registration fixed flag Xreg_det is set to “0” when a process of Step 2620 is executed.

When the CPU makes a “Yes” determination at Step 2615, the CPU proceeds to Step 2620 so as to register/memorize or store the registration entrance information Ient_reg, the registration inside information Iin_reg, and the registration area information Iarea_reg in the RAM as the parking lot information Ipark as described above. It should be noted that the registration inside coordinates XYin_reg and the registration inside luminance pattern information CTin_reg included in the parking lot information Ipark are acquired based on the feature points F acquired at Step 2450 of the routine shown in FIG. 24 which is executed just before the present time point. Next, the CPU proceeds to Step 2695 so as to end the present routine tentatively.

On the other hand, when the CPU makes “No” determination at Step 2615, the CPU proceeds to Step 2695 so as to end the present routine tentatively.

Also, when the CPU makes a “No” determination at Step 2605, the CPU proceeds to Step 2695 so as to end the present routine tentatively.

In addition, the CPU is configured or programmed to execute a routine shown in FIG. 27 each time the predetermined time elapses. When an appropriate time point comes, the CPU starts processing from Step 2700 shown in FIG. 27, and proceeds to Step 2705 so as to determine whether or not a start condition is satisfied. The start condition is satisfied when (i) the vehicle speed SPD is “0” and (ii) the driver operates the parking assist switch 48. When the start condition is satisfied, the CPU makes a “Yes” determination at Step 2705, and proceeds to Step 2710.

At Step 2710, the CPU acquires the masked image (the left masked image) of the left plane view image and the masked image (the right masked image) of the right plane view image, which are acquired at Step 2445 of the routine shown in FIG. 24 which is executed just before the present time point, and proceeds to Step 2715. At Step 2715, the CPU determines whether or not the image parts having the same luminance patterns as the luminance patterns of the registered entrance luminance pattern information CTent_reg is included in either one of the left masked image and the right masked image.

When the image parts having the same luminance patterns as the luminance patterns of the registered entrance luminance pattern information CTent_reg is included in either one of the left masked image and the right masked image, the CPU determines that (i) the vehicle VA stops by the entrance 62ent of the registered parking lot 62 and (ii) the automatic parking start condition is satisfied. Then, the CPU makes a “Yes” determination at Step 2715, and proceeds to Step 2720 so as to set a value of an assist flag Xassist to “1”. Thereafter, the CPU proceeds to Step 2795 so as to end the present routine tentatively.

When no image parts having the same luminance patterns as the luminance patterns of the registered entrance luminance pattern information CTent_reg is included in the left masked image and the right masked image, the CPU determines that (i) there is not the registered parking lot 62 in the vicinity of the vehicle 100 and (ii) the registration start condition is satisfied. Then, the CPU makes a “No” determination at Step 2715, and proceeds to Step 2725 so as to set the registration flag Xreg to “1”. Thereafter, the CPU proceeds to Step 2795 so as to end the present routine tentatively.

On the other hand, if the start condition is not satisfied when the CPU proceeds to Step 2705, the CPU makes a “No” determination at Step 2705, and proceeds to Step 2795 so as to end the present routine tentatively.

At Step 2715, the CPU may make a “Yes” determination at Step 2715 when (i) the image parts having the same luminance patterns as the luminance patterns of the registered entrance luminance pattern information CTent_reg is included in either one of the left masked image and the right masked image, and (ii) a position relationship among the entrance feature points Fent matches with a position relationship among the image parts having the same luminance patterns as the luminance patterns of the registered entrance luminance pattern information CTent_reg.

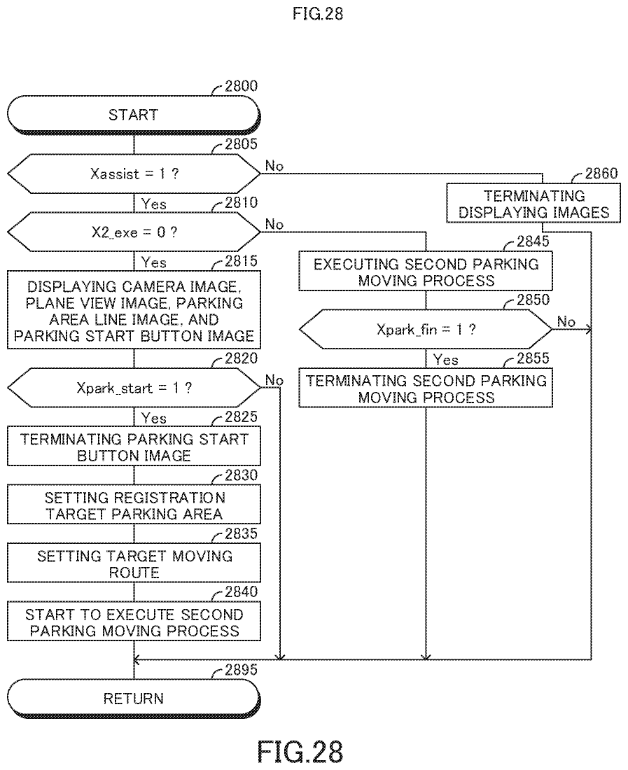

In addition, the CPU is configured or programmed to execute a routine shown in FIG. 28 each time the predetermined time elapses. When an appropriate time point comes, the CPU starts processing from Step 2800 shown in FIG. 28, and proceeds to Step 2805 so as to determine whether or not a value of a assist flag Xassist is “1”. The value of the assist flag Xassist is set to “1” when the vehicle VA stops by the entrance 62ent of the registered parking lot 62. On the other hand, the value of the assist flag Xassist is set to “0” when the vehicle moves away the registered parking lot 62 or when parking the vehicle 100 in the parking lot 62 is completed.

When the CPU makes a “Yes” determination at Step 2805, the CPU proceeds to Step 2810 so as to determine whether or not a value of a second parking moving process flag X2_exe is “0.” The value of the second parking moving process flag X2_exe is set to “1” when an execution of the second parking moving process is started. On the other hand, the value of the second parking moving process flag X2_exe is set to “0” when the execution of the second parking moving process is terminated.

When the CPU makes a “Yes” determination at Step 2810, the CPU proceeds to Step 2815 to display the camera image 51C, the plane view image 51P, the parking area line image 52, and the parking start button image 56 on the display 50.

Next, the CPU proceeds to Step 2820 so as to determine whether or not a value of a parking start flag Xpark_start is “1”. The value of the parking start flag Xpark_start is set to “1” when the touch interaction is applied to the parking start button image 56. On the other hand, the value of the parking start flag Xpark_start is set to “0” when the execution of the second parking moving process is started.

When the CPU makes a “Yes” determination at Step 2820, the CPU proceeds to Step 2825 so as to terminate displaying the parking start button image 56 on the display 50. Next, the CPU proceeds to Step 2830 so as to set the target parking area 61tgt to the parking area 61 corresponding to the parking area line image 52. Next, the CPU proceeds to Step 2835 so as to set the target moving route Rtgt to a moving route to move the vehicle 100 to the target parking area 61tgt. Next, the CPU proceeds to Step 2840 so as to start to execute the second parking moving process. Next, the CPU proceeds to Step 2895 so as to end the present routine tentatively.

On the other hand, when the CPU makes a “No” determination at Step 2820, the CPU proceeds to Step 2895 so as to end the present routine tentatively.

When the CPU makes a “No” determination at Step 2810, the CPU proceeds to Step 2845 so as to execute the second parking moving process. Next, the CPU proceeds to Step 2850 so as to determine whether or not a value of a parking completed flag Xpark_fin is “1.” The value of the parking completed flag Xpark_fin is set to “1” when the entire vehicle 100 has moved in the target parking area 61tgt. On the other hand, the value of the parking completed flag Xpark_fin is set to “0” when the execution of the second parking moving process is terminated.

When the CPU makes a “Yes” determination at Step 2850, the CPU proceeds to Step 2855 so as to terminate executing the second parking moving process. Next, the CPU proceeds to Step 2895 so as to end the present routine tentatively.

On the other hand, when the CPU makes a “No” determination at Step 2850, the CPU proceeds to Step 2895 so as to end the present routine tentatively.

When the CPU makes a “No” determination at Step 2805, the CPU proceeds to Step 2860 to terminate displaying the plane view image 51P, etc. on the display 50. Next, the CPU proceeds to Step 2895 so as to end the present routine tentatively.

The specific operations of the vehicle parking assist apparatus 10 have been described. According to the vehicle parking assist apparatus 10, the information on not the feature points of the object(s) in and/or around the parking lot 62 but the feature points F of the ground 63 in and/or around the parking lot 62 is registered/memorized as the registration entrance information Ient_reg (see Step 2020 in FIG. 20). Therefore, it is possible to assuredly determine that the entrance feature points Fent acquired this time are the registration entrance feature points Fent_reg when the vehicle 100 arrives at the entrance 62ent of the registered parking lot 62 if the situation surrounding the vehicle 100 and the parking lot 62 varies between the time of the registration entrance information Ient_reg having been registered and the time of the vehicle 100 arriving at the entrance 62ent of the registered parking lot 62 this time. As a result, it is possible to assuredly determine that the parking lot 62 at which the vehicle 100 arrives this time is the registered parking lot 62. Thus, the vehicle 100 can be autonomously parked in the registered parking lot 62.

The present disclosure is not limited to the above embodiment, and may employ various modifications within the scope of the present disclosure.

In the above embodiment, the clearance sonars 301 to 312 detect the object. The vehicle parking assist apparatus 10 may detect the object using other manners. For example, the CPU acquires, as a determination feature point, an image having a predetermined feature point having a predetermined feature amount from the camera image which is taken by each of the cameras 45 each time the predetermined time elapses. The CPU uses the determination feature point to detect the object from the camera image. When the determination feature point (a first determination feature point) which is acquired at a first time point is the same as the determination feature point (a second determination feature point) which is acquired at a second time point, the CPU estimates a moving route from the first time point to the second time point based on the vehicle speed Vs and the yaw rate Yr so as to estimate a position (a second position) of the vehicle VA at the second time point with respect to a position (a first position) of the vehicle VA at the first time point. The CPU specifies a position and a height of the determination feature point with respect to the camera based on the second time point, the position of the first determination feature point in the camera image taken at the first time point, the position of the second determination feature point in the camera image at the second time. If the height is equal to or higher than a predetermined threshold height, the CPU determines that the object is present.

The clearance sonars may be replaced with any types of sensors, as long as each of them is configured to radiate a radio wave (e.g., an infrared ray, and radar wave) and to receive a reflected radio wave so as to detect an object. Namely, the clearance sonars may be replaced with the infrared ray radar sensors and/or millimeter wave band radar sensors. Alternatively, the infrared ray radar sensors and/or millimeter wave band radar sensors may be employed in addition to the clearance sonars.

The number of the camera sensors 21 and the number of the clearance sonars are not limited those figures described in FIGS. 2 and 3.

What is claimed is:

1. A vehicle parking assist apparatus comprising:
a camera configured to take an image representing an area of surroundings of a vehicle; and
a controller configured to:
register, as parking lot information, information on a parking lot including a parking area into which the vehicle is going to be parked, based on a registration image being an image representing the parking lot that the camera takes when the controller receives a registration request for registering the parking area from a driver of the vehicle; and
autonomously park the vehicle into the parking area based on the parking lot information, when the vehicle is determined to have reached the parking lot specified by the parking lot information after the parking lot information had been registered,
wherein,
the controller is configured to:
acquire a feature image which is an image of a predetermined area size and has a specific feature from the registration image so as to register the feature image as the parking lot information; and
determine that the vehicle has reached the parking area specified by the parking lot information when an image part that has the same feature as the feature image is included in a post registration image so as to autonomously park the vehicle into the parking area in the parking lot based on the parking lot information, the post registration image being an image of an area taken by the camera after the controller has registered the parking lot information,
and wherein,
the controller is further configured to:
specify an object image being an image representing an object from the registration image when the object is present in the area corresponding to the registration image; and
acquire the feature image based on the registration image from which the specified object image is excluded.

2. The vehicle parking assist apparatus according to claim 1 further comprising a detection sensor configured to radiate wireless medium to detect the object by receiving the wireless medium that the object reflects,
wherein the controller is configured to:
determine that the object is present in the area corresponding to the registration image, in a case where the detection sensor detects the object when the controller receives the registration request; and
specify the object image from the registration image, based on the object which the detection sensor detects.

3. The vehicle parking assist apparatus according to claim 2,
wherein the detection sensor is configured to radiate the wireless medium to a predetermined radiation area in that a center axis is centered,
wherein the controller is configured to:
acquire a plane view image, the plane view image being an image of when an image taken by the camera is viewed from a viewpoint that is positioned above the camera;
acquire a virtual line between the camera and a furthest point of detection results representing the object detected by the detection sensor in the plane view image, the furthest point being a point that has a longest distance to the camera among the detection results;
acquire a first virtual line that extends from the furthest point in a same direction with the virtual line, the direction being a direction away from the camera;
acquire a second virtual line that extends from a closest point of the detection results in a direction that is parallel with the center axis of the radiation range of the detection sensor, the closest point being a point that has a shortest distance to the camera; and
specify, as the object image, an image of an area which is defined by the detection results, the first virtual line, and the second virtual line.

4. The vehicle parking assist apparatus according to claim 3,
wherein the detection sensor and the camera are configured to be mounted on the vehicle in such a manner that a direction of the center axis of the radiation range of the detection sensor matches with a direction of a center axis of a shooting range of the camera.

5. The vehicle parking assist apparatus according to claim 1,
wherein the controller is configured to:
specify the object image which is an image representing the object from the post registration image when the object is present in an area corresponding to the post registration image; and
determine whether or not an image other than the specified object image in the post registration image includes the feature image.
